(19) United States
(12) Patent Application Publication
(10) Pub. No.: US 2006/0153755 A1
(43) Pub. Date: Jul. 13, 2006

(54) Heat exchanger and reactor and radiation heater using the heat exchanger

(76) Inventors: Akira Obuchi, Ibaraki (JP); Junko Uchisawa, Ibaraki (JP); Akihiko Ooi, Ibaraki (JP); Tetsuya Namba, Ibaraki (JP); Norio Ogata, Ibaraki (JP); Atsushi Ogata, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/521,774

(22) PCT Filed: Jul. 18, 2003
(86) PCT No.: PCT/JP03/09202

§ 371 Date: Jan. 21, 2005

(30) Foreign Application Priority Data
Jul. 22, 2002 (JP) 2002-21210
Jul. 14, 2003 (JP) 2003-274039

(51) Int. Cl. B01J 19/00

(52) U.S. Cl. 422/198

(57) ABSTRACT

A self-heat exchange type heat exchanger which can provide a greater heat transfer area in a limited capacity, can be easily prepared and can lead to drastic enhancement of heat exchange efficiency. A heat exchanger having a partition type heat transfer material (BF) for parting a high temperature fluid (1) and a low temperature fluid (2) from each other, characterized in that the heat transfer material (BF) is bellows-shaped and is arranged such that both the fluids (1, 2) flow counter to each other mainly through the gap portion in the bellows section of the heat transfer material (BF) along the ridge line or valley line thereof and the heat transfer material (BF) has a fluid forwarding space portion (F) at one or both ends thereof crossing the ridge line of the bellows section for forwarding one of the fluids to the gap portion in the bellows section on the opposite side thereof, whereby the fluid which has been forwarded to the opposite side via the fluid forwarding space portion (F) acts as the other fluid to be heat-exchanged to perform heat exchange.

### TECHNICAL FIELD

The present invention relates to a heat exchanger and a reactor and a radiation heater using the same and more particularly to a technique which is suitable for the application to the art of heat engineering for saving the energy consumption and the art of environmental technique aiming at the purification of atmosphere or exhaust gas.

### BACKGROUND ART

As one of methods of improving the performance of partition type heat exchangers, an attempt has been widely made to increase the area of the heat transfer material (partition) as much as possible in a limited space capacity. A typical example of this method is to form the heat transfer material into bellows. Further, as another method of improving the performance of partition type heat exchangers, it has been practiced to arrange the direction of two fluid flows such that the two fluids flow in the same direction parallel to each other or in different directions counter to each other across the heat transfer surface. In order to realize such a flow, shell-and-tube heat exchangers, plate heat exchangers comprising many pressed heat transfer plates laminated on each other, spiral plate heat exchangers, etc. have been prepared.

On the other hand, when heat exchange is made on one fluid between upstream and downstream, the temperature of the fluid can be changed only at part thereof without consuming extra heat energy too much, making it possible to reduce the loss of heat energy in various chemical reaction or heat treatment processes. Further, as examples of an integration of such a self-heat exchanger to a catalyst or burner there have been known a type utilizing a self-heat exchanger having a spiral configuration (see literature; 39th Combustion Symposium, Presentation No. C145, Nov. 21-23, 2001, Yokohama), a type utilizing a rotary heat regenerative heat exchanger (see “Energy-environmentally designed gas burner with fuel consumption reduced by 50%”, Nihon Keizai Sangyo Shimbun, Jun. 25, 2002), a type utilizing a heat regenerative chamber type heat exchanger which switches the direction of flow path at a constant interval of time (see JP-A-2001-349524, literature: 39th Combustion Symposium, Presentation No. C144, Nov. 21-23, 2001, Yokohama), etc.

However, these various types of heat exchangers are disadvantageous in that they leave something to be desired in heat exchange area and their preparation is complicated. They leave something to be desired also in heat exchange efficiency and energy consumption.

The present invention is worked out in the light of these actual circumstances of the related art technique and an object of the present invention is to provide a heat exchanger which can provide a greater heat transfer area in a limited capacity, can be easily prepared and can lead to drastic enhancement of heat exchange efficiency and a reactor and a radiation heater comprising the same.

### DISCLOSURE OF THE INVENTION

In accordance with the present invention, the aforesaid problem can be solved by the following technical means.

(1) A heat exchanger having a partition type heat transfer material for parting a high temperature fluid and a low temperature fluid from each other, characterized in that the heat transfer material is bellows-shaped and is arranged such that both the fluids flow parallel or counter to each other mainly through the gap portion in the bellows section of the heat transfer material along the ridge line or valley line thereof.

(2) A self-heat exchange type heat exchanger having a partition type heat transfer material for parting a high temperature fluid and a low temperature fluid from each other, characterized in that the heat transfer material is bellows-shaped and is arranged such that both the fluids flow counter to each other mainly through the gap portion in the bellows section of the heat transfer material along the ridge line or valley line thereof and the heat transfer material has a fluid forwarding space portion at one or both ends thereof crossing the ridge line of the bellows section for forwarding one of the fluids to the gap portion in the bellows section on the opposite side thereof, whereby the fluid which has been forwarded to the opposite side via the fluid forwarding space portion acts as the other fluid to be heat-exchanged to perform heat exchange.

(3) A reactor comprising:

(a) a self-heat exchange type heat exchanger having a partition type heat transfer material for parting a high temperature fluid and a low temperature fluid from each other, characterized in that the heat transfer material is bellows-shaped and is arranged such that both the fluids flow counter to each other mainly through the gap portion in the bellows section of the heat transfer material along the ridge line or valley line thereof and the heat transfer material has a fluid forwarding space portion at one or both ends thereof crossing the ridge line of the bellows section for forwarding one of the fluids to the gap portion in the bellows section on the opposite side thereof, whereby the fluid which has been forwarded to the opposite side via the fluid forwarding space portion acts as the other fluid to be heat-exchanged to perform heat exchange; and

(b) a heating element or heat-absorbing element provided in the fluid forwarding space portion of the heat exchanger.

(4) The reactor as described in Clause (3), wherein a catalyst which accelerates exothermic reaction is supported on the entire surface of the heat transfer material of the heat exchanger or the surface thereof in the vicinity of the fluid forwarding space portion and as the fluid there is used one comprising the reactive components.

(5) The reactor as described in Clause (3), wherein as the heat transfer material of the heat exchanger there is used one having heat storage capacities, a catalyst which accelerates exothermic reaction is supported on the entire surface of the heat transfer material of the heat exchanger or the surface of the region close to the inlet/outlet of the fluid, an adsorbent which adsorbs the reactive components at low temperature and releases the reactive components at high temperature is supported on the entire surface of the heat transfer material of the heat exchanger or the surface thereof in the vicinity of the fluid forwarding space portion and as the fluid there is used one comprising the reactive components.

(6) The reactor as described in Clause (3), wherein a particle removing filter for catching and removing fine particles is provided in close contact with the side of the heat transfer material of the heat exchanger to which the fluid is forwarded.

(7) The reactor as described in Clause (4), wherein a particle removing filter for catching and removing fine particles is provided in close contact with the side of the heat transfer material of the heat exchanger to which the fluid is forwarded.

(8) The reactor as described in Clause (3) or (4), wherein the heat transfer material is provided with a filtrating function allowing gas permeation and particle catch and is not provided with a fluid forwarding space portion through which the fluid of the heat transfer material is forwarded.

(9) A radiation heater comprising:

(a) a self-heat exchange type heat exchanger having a partition type heat transfer material for parting a high temperature fluid and a low temperature fluid from each other, wherein the heat transfer material is bellows-shaped and is arranged such that both the fluids flow counter to each other mainly through the gap portion in the bellows section of the heat transfer material along the ridge line or valley line thereof and the heat transfer material has a fluid forwarding space portion at one or both ends thereof crossing the ridge line of the bellows section for forwarding one of the fluids to the gap portion in the bellows section on the opposite side thereof, whereby the fluid which has been forwarded to the opposite side via the fluid forwarding space portion acts as the other fluid to be heat-exchanged to perform heat exchange; and

(b) a burner disposed in the fluid forwarding space portion of the heat exchanger, characterized in that the wall parting the fluid forwarding space portion in which the burner is disposed from the exterior is formed by a heat radiating plate.

(10) A radiation heater comprising:

(a) a self-heat exchange type heat exchanger having a partition type heat transfer material for parting a high temperature fluid and a low temperature fluid from each other, wherein the heat transfer material is bellows-shaped and is arranged such that both the fluids flow counter to each other mainly through the gap portion in the bellows section of the heat transfer material along the ridge line or valley line thereof and the heat transfer material has a fluid forwarding space portion at one or both ends thereof crossing the ridge line of the bellows section for forwarding one of the fluids to the gap portion in the bellows section on the opposite side thereof, whereby the fluid which has been forwarded to the opposite side via the fluid forwarding space portion acts as the other fluid to be heat-exchanged to perform heat exchange; and

(b) an exothermic reaction-accelerating catalyst supported on the entire surface of the heat transfer material of the heat exchanger or the surface thereof in the vicinity of the fluid forwarding space portion, characterized in that the wall parting the fluid forwarding space portion from the exterior is formed by a heat radiating plate and as the fluid there is used one comprising the reactive components.

(11) The self-heat exchange type heat exchanger as described in Clause (2), wherein at least one air-permeable structure different from the heat transfer material is provided in the gap portion of the bellows section of the heat transfer material.

(12) The self-heat exchange type heat exchanger as described in Clause (11), wherein the air-permeable structure acts as a spacer.

(13) The self-heat exchange type heat exchanger as described in Clause (2), wherein a functional material such as catalyst, adsorbent, heat regenerating material and filter material is provided in the gap portion of the bellows section of the heat transfer material.

(14) The self-heat exchange type heat exchanger as described in Clause (2), wherein the surface of the heat transfer material is partly opened to form a fluid forwarding space portion.

(15) The self-heat exchange type heat exchanger as described in Clause (14), wherein the end of the heat transfer material is partly cut away to form a fluid forwarding space portion.

(16) The self-heat exchange type heat exchanger as described in clause (14), wherein the surface of the heat transfer material is partly provided with one or a plurality of openings which are closed at the circumference thereof to form a fluid forwarding space portion.

(17) The self-heat exchange type heat exchanger as described in Clause (12), wherein as the heat transfer material there is used one having no air permeability and the self-heat exchange type heat exchanger is formed by the heat transfer material, a structure for spacer and a filter cloth in combination.

(18) The self-heat exchange type heat exchanger as described in Clause (17), wherein the structure extends beyond the end of the fluid forwarding space portion of the heat transfer material and a filter cloth is formed therearound in the form of bellows.

(19) The self-heat exchange type heat exchanger as described in Clause (17), wherein the surface of the heat transfer material is partly opened to form a fluid forwarding space portion or the end of the heat transfer material is partly cut away to form a fluid forwarding space portion.

(20) The reactor as described in Clause (8), wherein the heat transfer material having a filtrating function is retained and formed in the form of bellows by using a structure for spacer.

### BRIEF DESCRIPTION OF THE DRAWINGS

FIG. 1 is a stereoperspective view illustrating a heat exchanger according to a first embodiment of implementation of the present invention.

FIG. 2(a) is a front perspective view of FIG. 1 and FIGS. 2(b) and (c) each are a front perspective view of modification.

FIG. 3 is a diagram illustrating another example of the first embodiment.

FIG. 4 is a diagram illustrating a further example of the first embodiment.

FIG. 5 is a perspective view illustrating a heat exchanger according to a second embodiment of implementation of the present invention.

FIG. 6(a) is a front perspective view of FIG. 5 and FIGS. 6(b) and 6(c) are a front perspective view of another example.

FIG. 7 is a front perspective view illustrating a reactor of a third embodiment based on a self-heat exchanger according to the present invention.

FIG. 8 is a front perspective view illustrating a reactor of a fourth embodiment based on a self-heat exchanger according to the present invention.

FIG. 9 is a front perspective view illustrating a reactor of a fifth embodiment based on a self-heat exchanger according to the present invention.

FIG. 10 is a front perspective view illustrating a reactor of a sixth embodiment based on a self-heat exchanger according to the present invention.

FIG. 11 is a front perspective view illustrating a reactor of a seventh embodiment based on a self-heat exchanger according to the present invention.

FIG. 12 is a front perspective view illustrating a reactor of an eighth embodiment based on a self-heat exchanger according to the present invention.

FIG. 13 is a diagram illustrating an alternatingly-sealed particle removing filter.

FIG. 14 is a front perspective view illustrating a radiation heater of a ninth embodiment based on a self-heat exchanger according to the present invention.

FIG. 15 is a front perspective view illustrating a radiation heater of a tenth embodiment based on a self-heat exchanger according to the present invention.

FIG. 16 is a diagram illustrating a modification example 1.

FIG. 17 is a diagram illustrating a modification example 1.

FIG. 18 is a diagram illustrating a modification example 2.

FIG. 19 is a diagram illustrating a modification example 2.

FIG. 20 is a diagram illustrating a modification example 3.

FIG. 21 is a diagram illustrating a modification example 4.

FIG. 22 is a diagram illustrating a modification example 5.

FIG. 23 is a diagram illustrating a modification example 6.

### BEST MODE FOR CARRYING OUT THE INVENTION

Embodiments of implementation of the present invention will be described hereinafter in connection with preferred examples.

### FIRST EMBODIMENT

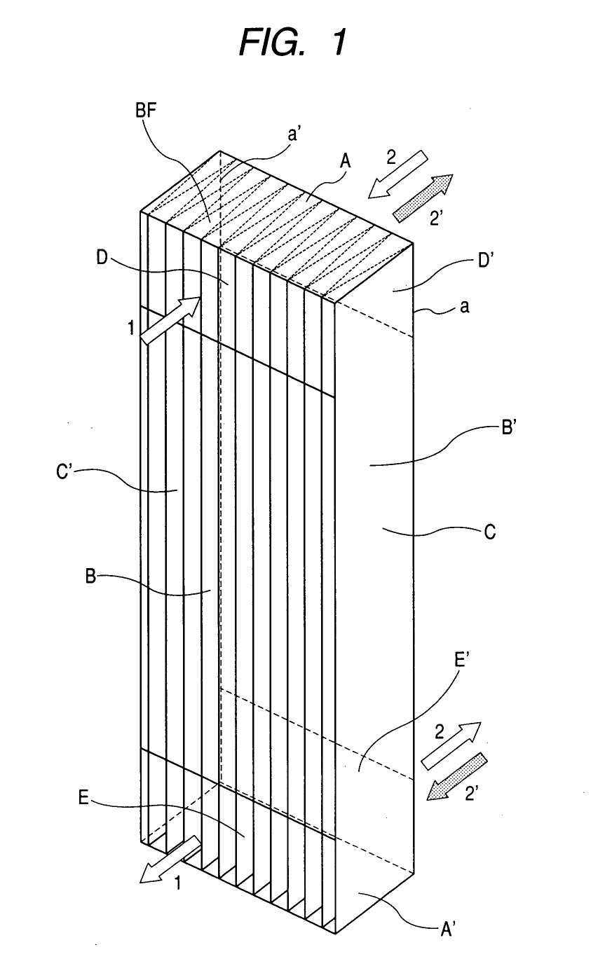

FIG. 1 depicts a heat exchanger according to a first embodiment of implementation of the present invention by stereoperspective view.

The heat exchanger of the present embodiment has a bellows type heat transfer material (BF). In this bellows type heat transfer material (BF), the partition parting a high temperature fluid 1 and a low temperature fluid 2 or 2′ from each other has a bellows (bellows or accordion) structure. The both side surfaces (A and A′) of the bellows type heat transfer material (BF) crossing the ridge line of the bellows section are sealed by adhering them to the upper and lower walls with a sealing material (not shown) or the like. Further, the both end portions (a and a′) of the heat transfer material (BF) parallel to the ridge line of the bellows section are sealed by welding them to the side walls (C, C′) constituting the both side surfaces of the heat exchanger or adhering them to the side walls (C, C′) with a sealing material (not shown). Further, referring to the front and rear side surfaces (B and B′) of the heat exchanger opposed to the ridge line of the heat transfer material (BF), the gap between the ridge line of the heat transfer material (BF) and the side surfaces (B and B′) of the vessel is sufficiently small as compared with the pitch of the bellows, and the inlets/outlets (D, D′, E, E′) of the two fluids are provided close to the upper and lower ends of the front and rear side surfaces (B and B′) opposed to the ridge line of the heat transfer material (BF).

By employing the aforesaid structure, two fluids having different temperatures which enter through the front inlet and the rear inlet, respectively, can flow through the respective gap portion along the ridge line of the bellows across the bellows type heat transfer material (BF) parallel (flows 1 and 2) or counter (1 and 2′) to each other. Further, by providing the heat transfer material with a bellows structure, a great heat transfer area can be provided in a limited capacity. Further, the bellows type heat transfer material can be prepared relatively easily and can drastically enhance heat exchange efficiency.

As the section of the heat transfer material (BF) there has been herein exemplified a triangular wave, but the present invention is not limited thereto, and a corrugated form or a flat form which is semicircular only at the ridge portion thereof may be used. As the heat transfer material (BF) there may be used one shaped by bending a foil-shaped stainless steel or one obtained by forming an uncalcined tabular ceramic material into a bellows and then calcining the ceramic material. Further, as a method of preventing the damage or deformation of the bellows type heat transfer material due to external compressive force, the surface of the aforesaid stainless steel or the uncalcined tabular ceramic may be roughened or a corrugated plate may be bent in the direction not perpendicular or parallel to the ridge line of corrugation to form a bellows such that the adjacent surfaces of bellows come in contact with each other.

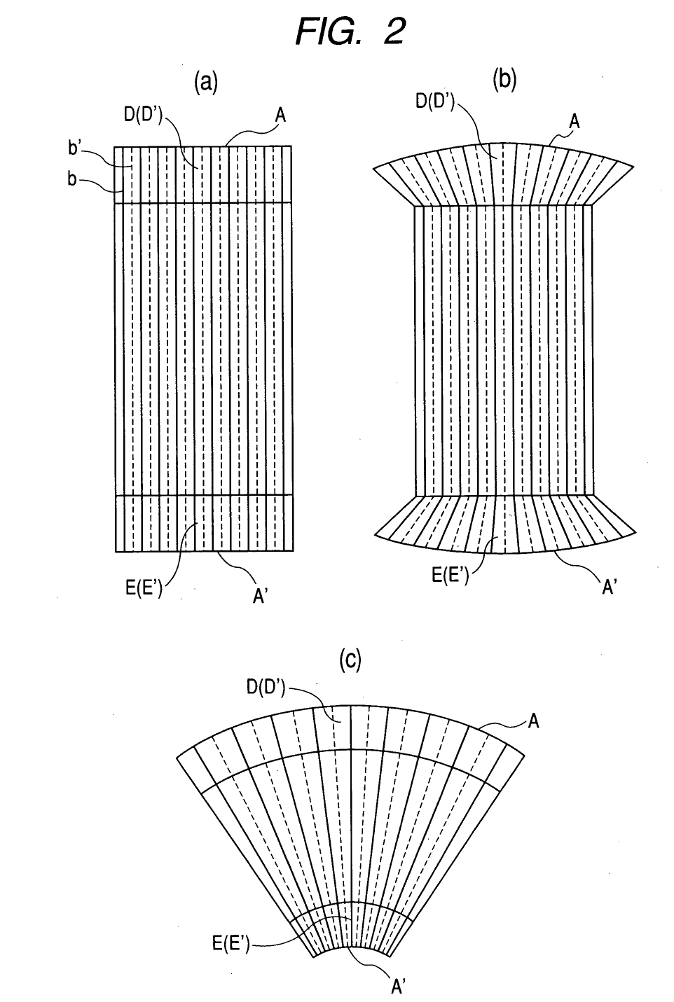

FIG. 2(a) is a front perspective view of the structure shown in FIG. 1 as viewed on the inlet/outlet of the fluid 1. D and E are the same inlet/outlet of the fluid 1 as in FIG. 1. Inlet/outlet D′ and E′ of the fluid 2 are provided on the respective back side of the inlet/outlet D and E. Further, b and b′ are the ridge line and valley line of the bellows type heat transfer material (BF), respectively, as viewed on the front. The general shape of the bellows type heat transfer material (BF) is not limited to rectangular parallelepiped as exemplified herein, and as shown in FIG. 2(b), the inlet/outlet portion of fluid may be enlarged like fan to reduce the flow resistance of this portion. Further, as shown in FIG. 2(c), the bellows type heat transfer material may be generally fan-shaped. In this manner, the rate of flow of the fluid can be changed along the flow, optionally making it possible to realize more efficient heat exchange.

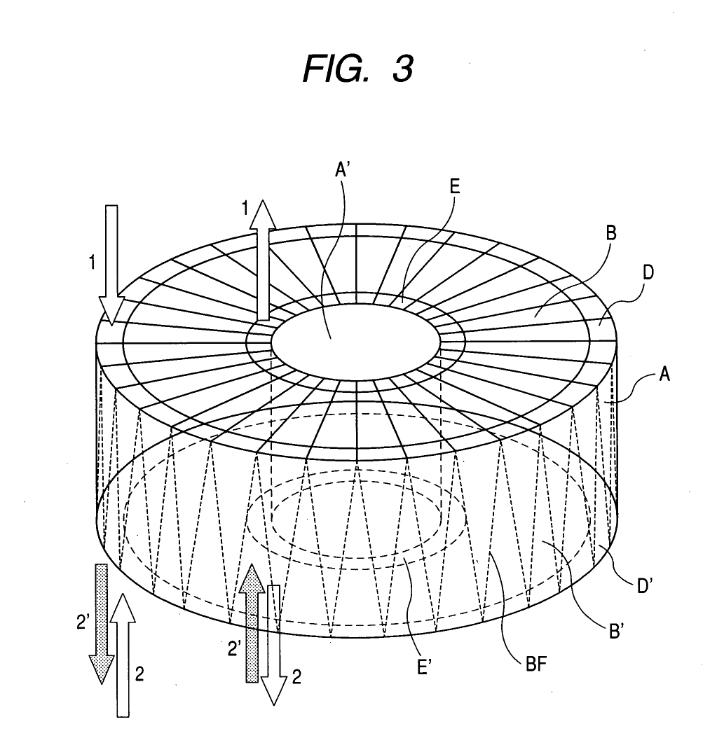

Further, a form as shown in FIG. 3 obtained by extending the form of FIG. 2(c) circumferentially one round may be employed. In this case, the ends of the heat transfer material (BF) parallel to the ridge line are sealed to each other by welding them to each other, by adhering them to each other with a sealing material or like means. The various signs in FIG. 3 indicate those corresponding to FIG. 1. D, E, D′ and E′ are inlet/outlet of the fluids 1 and 2 (2′), respectively, as in FIG. 1 and by changing the direction of the fluid 2, the flow of fluid may be parallel flow (2) or counter flow (2′). In this structure, sealing at outer and inner surfaces A and A′ of the cylinder, respectively, are needed. However, the both ends (a and a′ in FIG. 1) parallel to the ridge line of the bellows are lost in this cylindrical form. Referring to the surfaces B and B′, it suffices if the gap between the ridge line of the heat transfer material (BF) and the side surface of the vessel is sufficiently small as compared with the pitch of the bellows as in the case of FIG. 1, and no sealing is needed.

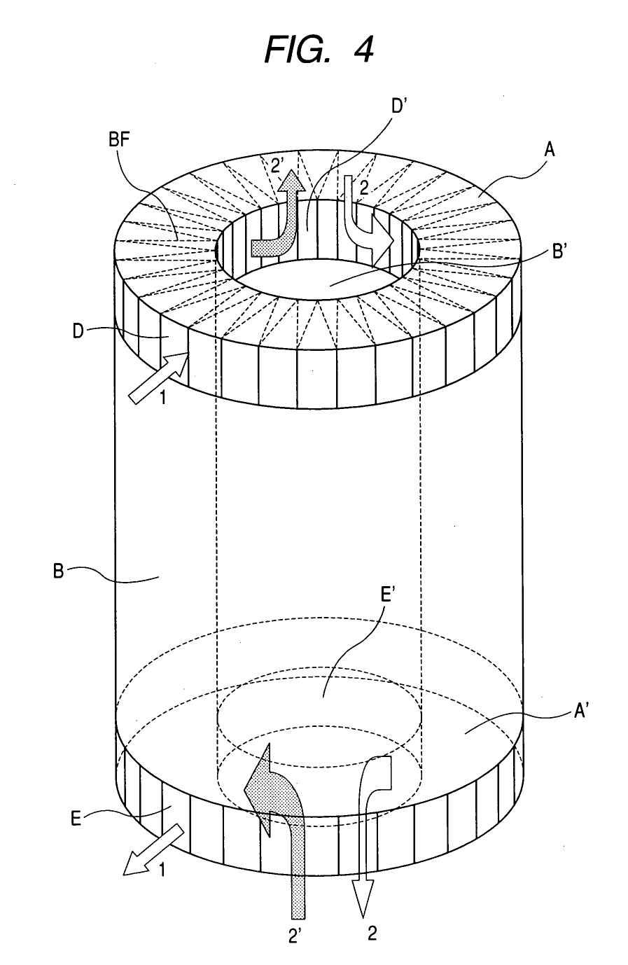

Further, a structure having a bellows type heat transfer material disposed as shown in FIG. 4 which is similarly cylindrical is possible. The various signs in FIG. 4, too, indicate those corresponding to FIG. 1. In this case, the heat transfer material (BF) is disposed in the space interposed between the outer cylinder B and the inner cylinder B′. At the end surfaces (A and A′) perpendicular to the ridge line of the heat transfer material (BF), the surface of the respective vessel and the heat transfer material (BF) are sealed to each other by adhering them to each other with a sealing material or like means. Further, the both ends parallel to the ridge line of the heat transfer material (BF) are needed to be sealed to each other by completely adhering or welding them to each other so that the fluid does not leak to the opposite surface of the heat transfer material (BF), but the sealed portion with respect to the vessel wall at this portion is lost and is not needed as in the case of the structure of FIG. 3. On the other hand, at the surfaces B and B′, it suffices if the distance between the ridge line of the heat transfer material (BF) and the various surfaces is sufficiently smaller than the pitch of the bellows at the various surfaces and no sealing is needed as in the case of FIG. 1.

### SECOND EMBODIMENT

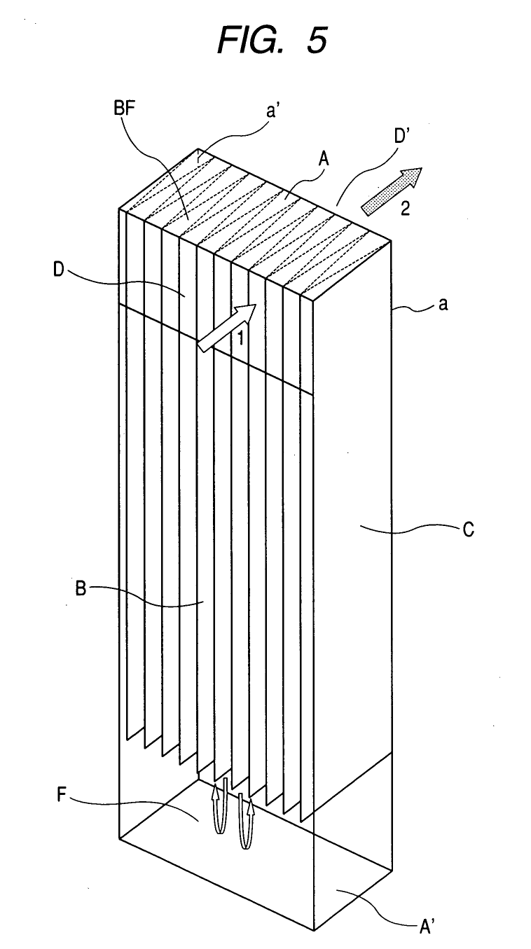

A heat exchanger according to a second embodiment of implementation of the present invention is shown in FIG. 5. The heat exchanger of the present embodiment is characterized by a partition type heat exchanger for two fluids having the configuration of FIG. 1 except that D and D′ are inlet and outlet, respectively, instead of pairs of inlets/outlets (D, D′, E, E′) disposed opposed to each other across the bellows type heat transfer material (BF) and a fluid forwarding space portion (F) for forwarding the fluid which has entered through the inlet (D) to the opposite side of the heat transfer material (BF) is provided rather than sealing one end (A′) of the heat transfer material (BF) by adhesion. The other configurations are the same as in the first embodiment.

By employing such a structure, a self-heat exchange type heat exchanger which allows one fluid to flow downstream and upstream counter to each other across the bellows type heat transfer material (BF) is realized. Further, similar modification can be made in all the heat exchangers of FIGS. 2, 3 and 4 to obtain corresponding self-heat exchanger.

In addition to the action and effect of the first embodiment, the heat exchanger of the present embodiment is provided with drastic simplification of the structure for sealing piping and fluid as compared with the self-heat exchanger utilizing the conventional heat exchanger structure represented by shell-and-tube heat exchanger and is advantageous in that even when the number of bellows increases, the entire and sealing structures are not complicated, making it possible to provide a self-heat exchanger having an extremely high heat exchange efficiency.

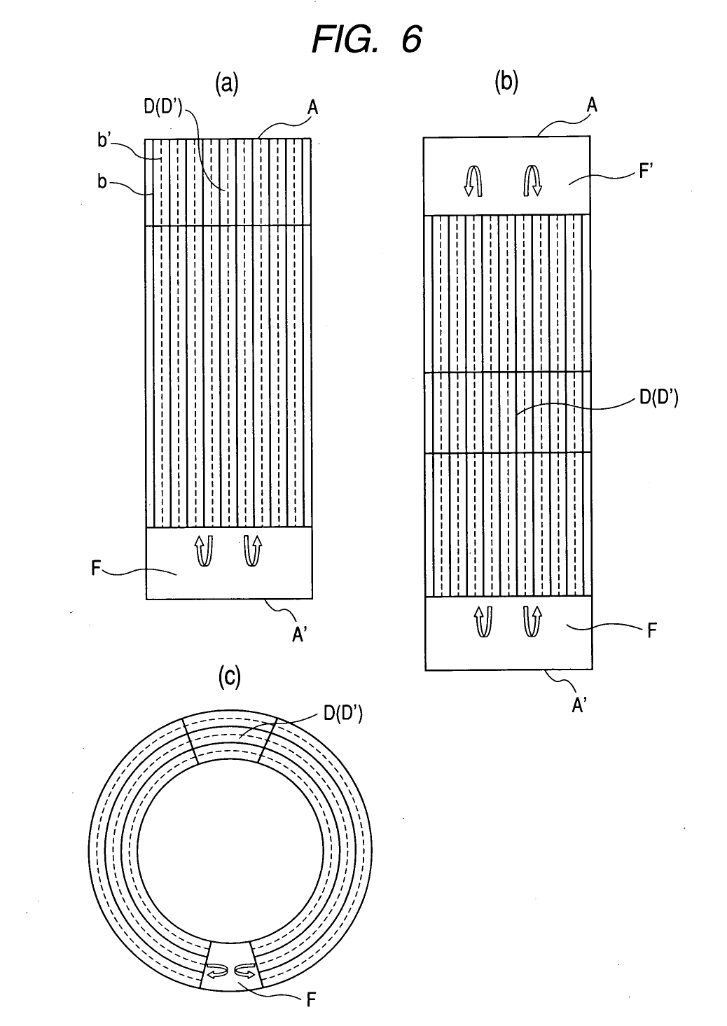

FIG. 6(a) depicts the configuration of the self-heat exchanger of FIG. 5 by front perspective view. In the drawing, b indicates the ridge line and b′ indicates the valley line (corresponding to the ridge line of the bellows on the side thereof opposite the ridge line b).

In the second embodiment, the number of the fluid forwarding space portions (F) showing extreme temperature is not necessarily only one, but fluid inlet/outlet (D, D′) may be provided at the middle point along the ridge line of the heat transfer material (BF) as shown in FIG. 6(b) so that the fluid which has entered through the inlet (D) is branched to upward flow and downward flow which are then forwarded to space portions (F, F′) adjacent to different end surfaces of the heat transfer material (BF), respectively, from which they join each other and then come out of the heat exchanger through the outlet (D′). In this arrangement, sealing between the heat transfer material (BF) and the vessel wall at the surface (A) is not needed.

Further, FIG. 6(c) depicts the configuration of the self-heat exchanger having an inlet/outlet allowing branch of fluid provided at the center thereof as shown in FIG. 6(b) which is modified such that the bellows type heat transfer material (BF) is generally shaped in a rectangular parallelepiped which extends continuously along the ridge line thereof and is formed annular to allow the both ends of the heat transfer material (BF) crossing the ridge line to share the same fluid forwarding space portion (F). This modification is advantageous in that sealing at the end surface of the bellows section is not needed while keeping the number of space portions (F) showing extreme temperature at only one.

### THIRD EMBODIMENT

The reactor based on the self-heat exchanger having the configuration shown in FIG. 5 will be described hereinafter.

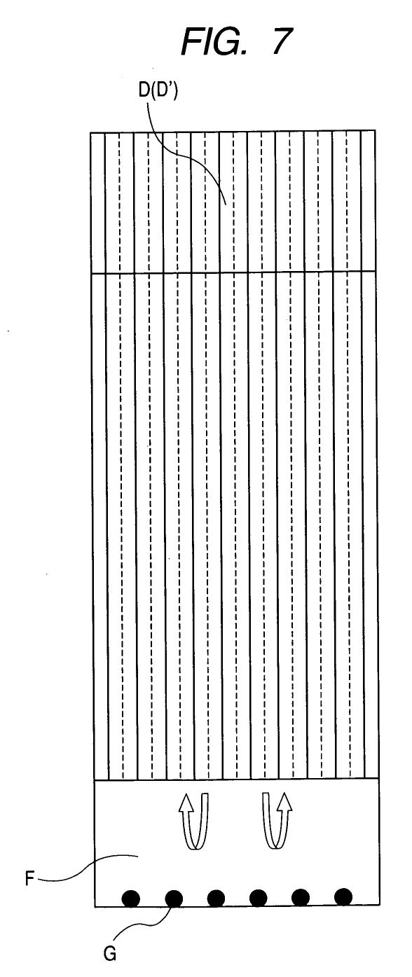

The reactor shown in FIG. 7 is a reactor based on the self-heat exchanger shown in FIG. 5 integrated to a self-heat exchanger comprising a heating element (heater) or heat absorber (G) incorporated in the fluid forwarding space portion (F). In the reactor having such a configuration, heat is transferred between a high (low) temperature incoming fluid and an outgoing fluid which has been heated (cooled) via the space portion (F) showing maximum (minimum) temperature so that even when the space portion (F) shows a considerably high (low) temperature, the temperature of the outlet (D′) is not so high (low) relative to that of the inlet (D) (e.g., 20° C., 700° C., 90° C. at D, F and F′, respectively). Such a configuration can be used as a reactor which allows the use of reduced energy (electric power) for heating when it is required that heating be made to cause the exothermic reaction of fluid but it is desired to prevent as much as possible the change of temperature at which the fluid is again withdrawn. Accordingly, it can be expected to apply such a configuration to all chemical reaction apparatus. Theoretical estimation of properties of third embodiment:

The properties of the self-heat exchange type reactor according to the third embodiment shown in FIG. 7 will be roughly estimated. Supposing that the shape of bending of the ridge portion (or valley portion) of the bellows section of the heat transfer material (BF) is semicircle and the adjacent heat transfer surfaces are parallel to each other, the heat transfer in this case can be regarded as heat transfer between different fluids across a parallel flat plate. Let us suppose that the total area of the bellows is A (m²), the heat transfer coefficient from the high temperature fluid to the low temperature fluid across the heat transfer surface is K (W/m²·K) and the gap between the adjacent surfaces of bellow is d (m) In the case where the gap d is about 10⁻³ (=1 mm), it is expected that the fluid flowing at a rate on the order of 1 m/s in this reactor behaves as a laminar flow. In the laminar flow through the gap between parallel flat plates, the heat transfer coefficient between the wall surface and the high or low fluids, h (W/m²·K) is given by the following equation:
h=140/17×λ/D
under the conditions that the heat flux is constant (counterflow heat exchangers allow this approximation). Herein, the coefficient 140/17 is a nondimensional number which is normally called Nusselt number and is theoretically determined under given conditions. λ is the thermal conductivity (W/m·K) of fluid and D is a dimension called representative length, and in the case of parallel flat plate,
D=2d
Further,
K=1/2h
Combining these equations, the following equation is obtained after all;
K=35/17×λ/d
In FIG. 7, supposing that a heating element is used, the heat generation from the heating element is Q (W), the heat capacity flow rate of fluid (having no temperature dependence) is μCₚ (J/Ks) and the heat exchange element is ideally heat-insulated to make no heat release other than waste heat contained in the outgoing fluid, the relationship between the inlet temperature Tᵢ and the outlet temperature Tₒ of fluid is given by the following equation:
Tₒ−Tᵢ=Q/(μCₚ)
where μ represents the mass flow rate (kg/s) of fluid; and Cp represents the specific heat at constant pressure (J/kg·K) of fluid. Further, the following relationship is established between the temperature Tᵣᵢ of the fluid flowing into the fluid forwarding space portion (F) and the temperature Tᵣₒ of the fluid flowing out of the fluid forwarding space portion (F):
Tᵣₒ−Tᵣᵢ=Q/(μCₚ)
Defining the heat exchange efficiency φ indicating what percentage of heat moves from the high temperature fluid to the low temperature fluid to:
φ=(Tᵣₒ−Tₒ)/(Tᵣₒ−Tᵢ)
the heat exchange efficiency φ is given by the following equation:
φ=(Tᵣₒ−Tₒ)/(Tᵣₒ−Tₒ+Tₒ−Tᵢ)=(Tᵣₒ−Tₒ)/(Tᵣₒ−Tₒ+Q/(μCₚ))
Further, since:
μCₚ(Tᵣₒ−Tₒ)=KA(Tₒ−Tᵢ)=35/17×λ/d·A·Q/(μCₚ)
the heat exchange efficiency φ is given by the following equation:
φ=(35/17×λ/d·A)/(μCₚ+(35/17×λ/d·A)) (1)

The results of the relationship between air flow rate v (L/s) and heat exchange efficiency φ determined on a bellows type heat transfer material (BF) obtained by bending a thin rectangular plate having a length of 1,600 mm and a width of 200 mm (i.e., A=0.32 m²) at an interval of 40 mm to make 40 surfaces which are disposed apart from each other at a gap of 1 mm (=d) using the equation (1) supposing that as the incoming fluid there is used 20° C. air (density ρ=1.166 kg/m³; specific heat at constant pressure: 1,005 J/kg·K) and the heat exchanger operates under the conditions that λ (=0.0257 W/m·K) is constant at about 20° C. are set forth in Table 1. In this case, μ is calculated by the following equation:
μ=ρv×10⁻³ (2)

TABLE 1
Relationship between flow rate and heat exchange
efficiency in the case where air having a temperature
around room temperature is used as fluid
(φ is calculated from the equations (1) and (2) defined
herein using the following various parameters)

| | Heat exchange |
|---|---|
| Flow rate | efficiency |
| V(L/s) | φ × 100 (%) |
| 1 | 93.5 |
| 2 | 87.8 |
| 3 | 82.8 |

| | |
|---|---|
| ρ(kg/m³) = | 1.166 |
| Cp(J/kgK) = | 1005 |
| d(m) = | 0.001 |
| λ(W/msK) = | 0.0257 |
| A(m²) = | 0.32 |

The volume V of this bellows-shaped heat exchange element is only about 0.32 L. Accordingly, the spatial velocity at v of 1 L/s is 3,600 v/V=11,250 h−1. Even at such a high spatial velocity, it can be expected to attain an extremely high performance, that is, a heat exchange efficiency of 93.5% so far as the heat transfer material (BF) can be bent completely into a parallel flat plate as supposed in calculation. Similarly, even at a spatial velocity v as high as 2 L/s (SV=22,500 h¹) or 3 L/s (SV=33,750 h⁻¹), a heat exchange efficiency as high as 87.8% or 82.8%, respectively, can be obtained. Verification experiment on performance of third embodiment:

The results of examination of performance of a reactor (No. 1) having the same dimension as the aforementioned calculation example made on experimental basis are set forth in Table 2. As the material of heat transfer material there is used a stainless steel foil having a thickness of 0.03 mm. Further, as the heating element, a Kanthal wire is provided in the fluid forwarding space portion (F), and the Kanthal wire is energized to generate heat at about 50 W. At v of 1, 2 and 3 L/s, a heat exchange efficiency of 78, 69 and 68%, respectively, are obtained.

TABLE 2
Test on heat exchange properties by No.
1 reactor made on experimental basis

| | | | Folded portion | heat |
|---|---|---|---|---|
| Flow | Inlet | Outlet | Outgoing side | exchange |
| rate | temperature | temperature | temperature | efficiency* |
| (L/s) | Tᵢ (° C.) | Tₒ (° C.) | Tᵣₒ (° C.) | φ (%) |
| 1.1 | 23 | 52 | 152 | 78 |
| 2.0 | 23 | 41 | 82 | 69 |
| 2.9 | 22 | 34 | 60 | 68 |

*φ = {(Tᵣₒ − Tₒ)/(Tᵣₒ − Tᵢ)} × 100

### FOURTH EMBODIMENT

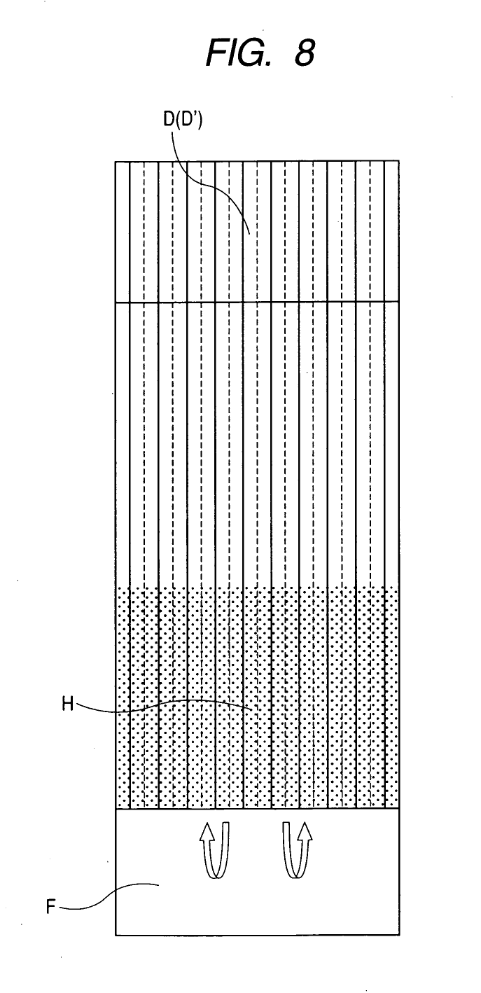

FIG. 8 depicts the reactor according to the fourth embodiment of the present invention. This reactor performs heating in the reactor described in FIG. 7 by the catalytic reaction of reactive components contained in the fluid. This reactor is a catalytic reactor having the same configuration as the self-heat exchanger of FIG. 5 except that a catalyst (H) is supported on the entire surface of the heat transfer material (BF) or the surface thereof close to the end surface to which the fluid is forwarded so that it is integrated to the self-heat exchanger. In this reactor, the integration of a self-heat exchange structure comprising a bellows type heat transfer surface having a high heat exchange efficiency and a monolithic catalyst carrier structure to each other makes it possible to obtain a temperature high enough to cause catalytic reaction inside the reactor without raising the temperature of the reaction fluid so much as a result (e.g., 20° C., 300° C. and 50° C. at D, F and D′, respectively) and hence realize a high efficiency and energy-saving reaction. Verification experiment on performance of fourth embodiment:

In order to actually verify the performance of the self-heat exchange type catalytic reactor of the fourth embodiment, a rectangular parallelepiped bellows type heat transfer material as shown in FIG. 5 having a general size of about 40 mm×40 mm×200 mm is prepared as a heat transfer material by bending a stainless steel foil having a thickness of 0.03 mm, a width of 200 mm and a length of 2,720 mm at right angle with respect to longitudinal direction at an interval of 40 mm to make 68 surfaces. The gap between the adjacent surfaces of the bent heat transfer material is about 0.59 mm. Further, the heat transfer material is coated with an alumina-supported platinum catalyst over the area thereof ranging over a width of about 40 mm from the end of the side to which the fluid is forwarded toward the inlet/outlet of fluid, and then installed in a rectangular parallelepiped vessel made of a stainless steel plate having a thickness of 0.6 mm. This vessel is provided with inlet/outlet corresponding to D and D′ of FIG. 5 to allow the passage of air containing a low concentration volatile organic compounds (VOC). The results of various VOC removing properties and heat exchange properties of No. 2 reactor made on experimental basis are set forth in Table 3. These VOC's having a concentration of 0.3% or less contained in room temperature air are continuously decomposed by 90% or more only by heat generated by its oxidation, i.e., in self-oxidative manner, without externally applying auxiliary heat except during ignition. Referring to toluene, toluene having a concentration of about 0.1% is completely decomposed to CO₂ and H₂O at a removal rate of about 94% even at a spatial velocity as relatively high as 1.1 L/s (SV=12,400 h⁻¹).

TABLE 3
Catalytic combustion of low concentration combustible gas by self-heat exchange
type catalytic reactor (No. 2 reactor made on experimental basis)

| | | | | | | | Temperature | Heat |
|---|---|---|---|---|---|---|---|---|
| Reactive | Flow | Inlet | Outlet | Percent | Inlet | Outlet | of folded | exchange |
| gas | rate | concentration | concentration | removal | temperature | temperature | portion | efficiency* |
| component | L/s | % | % | % | ° C. | ° C. | ° C. | % |
| Ethylene | 0.32 | 0.2515 | 0.0038 | 98.5 | 21 | 88 | 323 | 78 |
| Propane | 0.32 | 0.2886 | 0.0123 | 95.7 | 27 | 153 | 585 | 77 |
| Ethanol | 0.30 | 0.291 | 0.023 | 92.0 | 20 | 97 | 378 | 79 |
| Toluene | 0.31 | 0.080 | 0.004 | 95.1 | 21 | 76 | 300 | 80 |
| | 0.62 | 0.100 | 0.005 | 95.4 | 23 | 124 | 416 | 74 |
| | 1.14 | 0.108 | 0.007 | 93.7 | 23 | 139 | 441 | 72 |
| | 2.00 | 0.151 | 0.014 | 90.4 | 23 | 190 | 487 | 64 |

*Heat exchange efficiency = {(Temperature of folded portion − outlet temperature)/(Temperature of folded portion − inlet temperature)} × 100

In painting workshops, etc, the pollution of air with volatile organic compounds (so-called VOC: volatile organic compounds) such as toluene and xylene raises problems. However, when the present reactor is used, air containing 0.1% of toluene can be oxidatively decomposed by utilizing only the heat developed by the catalytic combustion of toluene in the presence of an oxidation catalyst such as platinum catalyst to keep the reaction temperature without requiring additional heat energy. In other words, the present reactor can be expected to be applied to apparatus of disposing low concentration volatile organic contaminants in air, etc.

### FIFTH EMBODIMENT

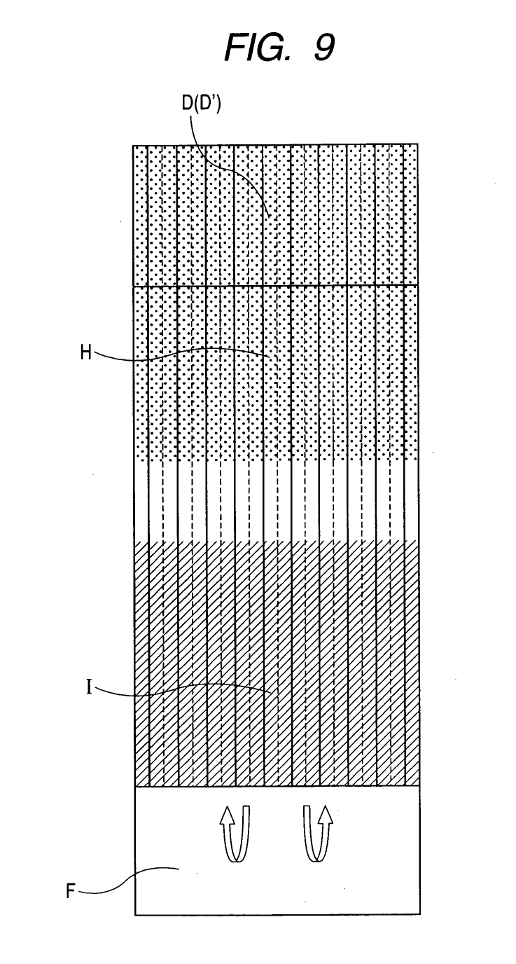

FIG. 9 indicates a reactor according to the fifth embodiment of implementation of the present invention. This reactor has the same configuration as the self-heat exchanger of FIG. 5 except that the heat transfer material (BF) is provided with heat storage capacities, a catalyst (H) allowing the reaction of reactive components contained in the fluid is supported on the entire surface of the heat transfer material (BF) or the surface thereof close to the inlet/outlet of the fluid and an adsorbent (I) which adsorbs reactive components at low temperature and releases reactive components at high temperature is supported on the entire surface of the heat transfer material (BF) or the regional surface of the heat transfer material (BF) close to the end thereof to which the fluid is forwarded.

In accordance with the present reactor, the reactive components are adsorbed and caught by the adsorbent (I) while the temperature is low under the transient reaction conditions that the fluid temperature gradually rises. As the fluid temperature rises, the heat transfer material (BF) is heated beginning with the site thereof close to the inlet/outlet thereof, but the heating of the portion to which the fluid is forwarded is so much behind the aforementioned site due to the heat storage capacities of the heat transfer material (BF). Therefore, when heating is made all over the heat transfer material (BF) so completely as to cause the heat transfer material (BF) to release the reactive components which have been adsorbed thereby, the temperature of the site in the vicinity of the inlet/outlet of fluid is further raised to attain the conditions under which catalytic reaction can occur, making it possible to decompose the reactive components at a high efficiency and prevent them from being emitted unreacted. The reactor having such a configuration can be used as an automobile exhaust gas converter of disposing hydrocarbon discharged during the engine starting period and can be difficultly disposed by the conventional catalytic converter because the temperature of exhaust gas is low.

### SIXTH EMBODIMENT

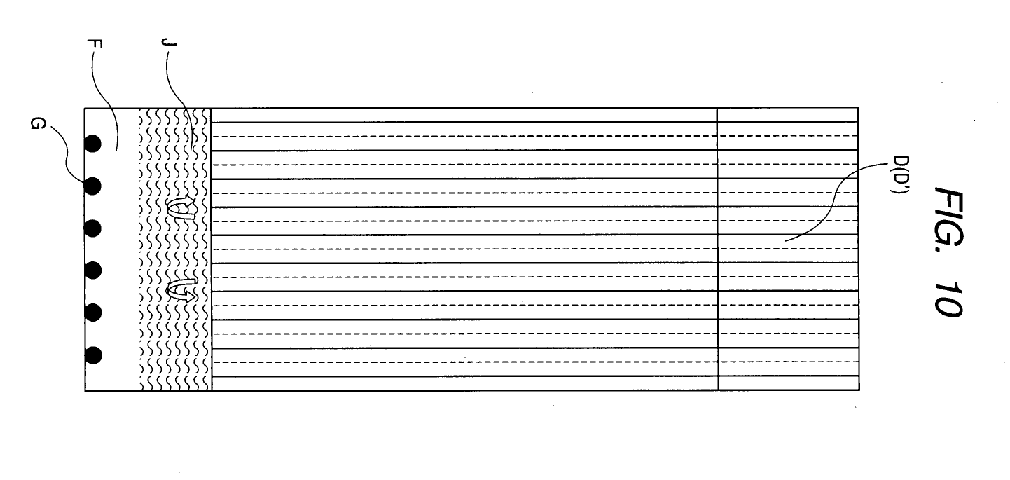

FIG. 10 depicts a reactor according to the sixth embodiment of implementation of the present invention. This reactor has the same configuration as the reactor integrated to a self-heat exchanger provided with a heating element (G) of FIG. 7 except that a filter (J) capable of catching fine particles is provided in close contact with the end surface of the heat transfer material (BF) to which the fluid is forwarded.

In accordance with the present reactor, the disposition of the filter (J) in the space portion (F) showing highest temperature makes it possible to provide a self-regenerative filter trap capable of disposing fine particles made of carbon or high boiling organic components which can be decomposed at high temperature without raising the temperature of inlet/outlet of fluid so much, i.e., applying so high a thermal energy. Particulate matter (PM), particularly solid carbon content (soot), in the exhaust gas from diesel engine cannot be readily oxidized away unless the temperature is 600° C. or more. Heretofore, there has been a technique which comprises intermittently raising the temperature of exhaust gas to this temperature to oxidize PM caught by the filter, thereby regenerating the filter, but this technique requires so much energy (fuel). However, the present reactor is advantageous in that the temperature at which PM oxidation can readily occur can be obtained without applying so much energy. In the present reactor, the supporting of a catalyst for PM oxidation containing Mo or V on the filter (J) makes it possible to lower the temperature to be reached to 500° C., 400° C. or the like and further reduce energy loss. The present reactor can be used as a self-regenerative diesel particulate filter.

### SEVENTH EMBODIMENT

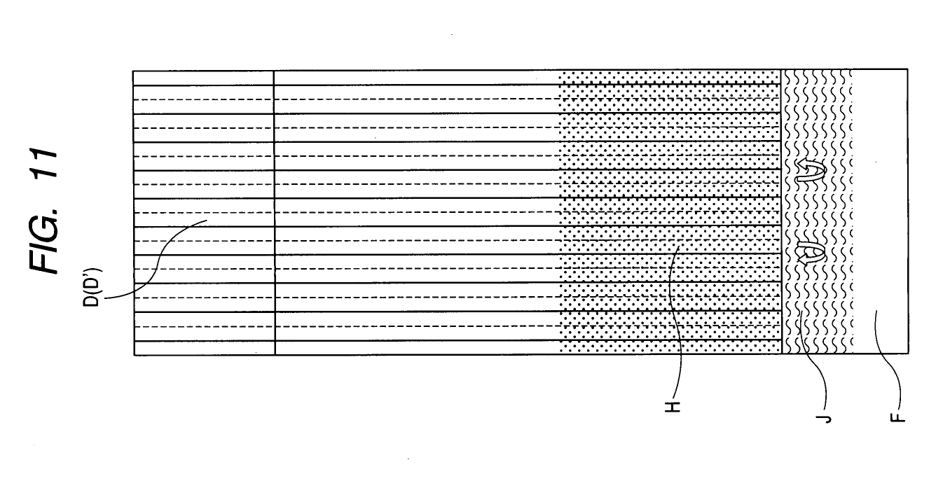

FIG. 11 depicts a reactor according to the seventh embodiment of implementation of the present invention. This reactor has the same configuration as the self-regenerative filter trap described in FIG. 10 except that heating is carried out by catalytic reaction instead of providing the heating element (G). In other words, the present reactor comprises a filter (J) of catching and removing fine particles provided on the end surface of the heat transfer material (BF) to which the fluid is forwarded.

In accordance with the present reactor, the temperature in the filter (J) can be raised as necessary by adding catalytic reaction components to the fluid as necessary. The present reactor can be used as a self-regenerative filter trap which disposes PM in the exhaust gas in diesel engine as in the case of FIG. 10. When heating is carried out by the catalytic oxidation of fuel, the utilization efficiency of heat energy is higher than via heating element, making it more practical. The present reactor, too, can be used as a self-regenerative diesel particulate filter.

### EIGHTH EMBODIMENT

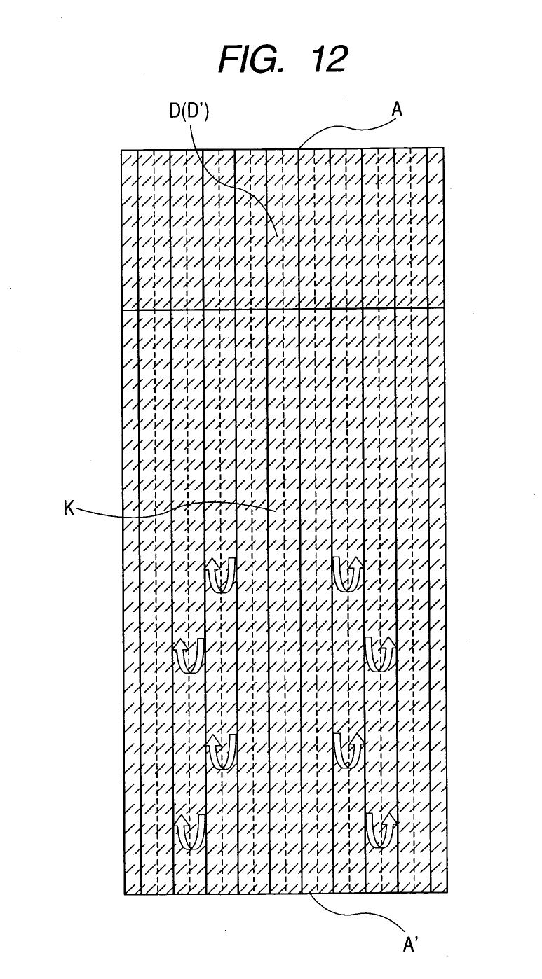

FIG. 12 depicts a reactor according to the eighth embodiment of implementation of the present invention. This reactor has the same configuration as the self-heat exchanger of FIG. 5 except that as the heat transfer material (BF) there is used a porous material (K) having a filtrating function, the space portion (F) on the end of the heat transfer material (BF) to which the fluid is forwarded is eliminated and sealing is made between the heat transfer material (BF) and the surface (A′).

In the reactor having this configuration, the fluid which has entered through the inlet (D) passes through the wall of the heat transfer material to the opposite side thereof from which it is then discharged through the outlet (D′). During this procedure, fine particles suspended in the fluid are caught by the surface of the heat transfer material. In the present reactor, by supporting a catalyst which accelerates the catalytic oxidation reaction on the heat transfer material (BF) and by adding the reactive components to the fluid before entering the present reactor, the heat transfer material/filter itself is heated by the heat developed by the catalytic reaction as in the case of FIG. 8 or 11. Further, the same self-heat exchange type flow path structure as in FIG. 5 makes it possible to raise the temperature of the heat transfer material as in the lower part thereof and realize the decomposition and removal of fine particles at the site under a certain region. The degree of filter regeneration (ease of permeation of fluid) may be grasped by means such as measurement of difference in pressure between before and after the present reactor and may be controlled by adjusting the degree of heating of the reactor until the necessary level is reached.

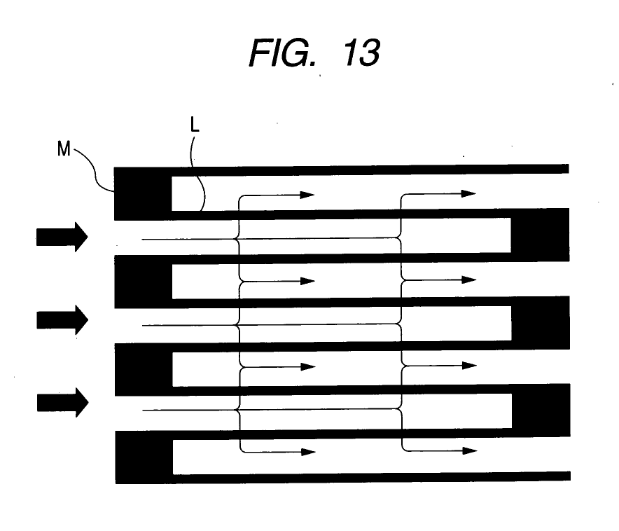

Further, the present reactor can provide the same filter area density as in the alternatingly-sealed particle filter which has heretofore been widely used (In FIG. 13, L indicates a porous wall having a filtrating function, and M indicates a sealer which alternatingly seals inlets/outlets of honeycomb flow path) and has self-heat exchange properties, making it possible to perform filter regeneration with little waste of heat energy. The present reactor, too, can be used as a self-regenerative diesel particulate filter.

### NINTH EMBODIMENT

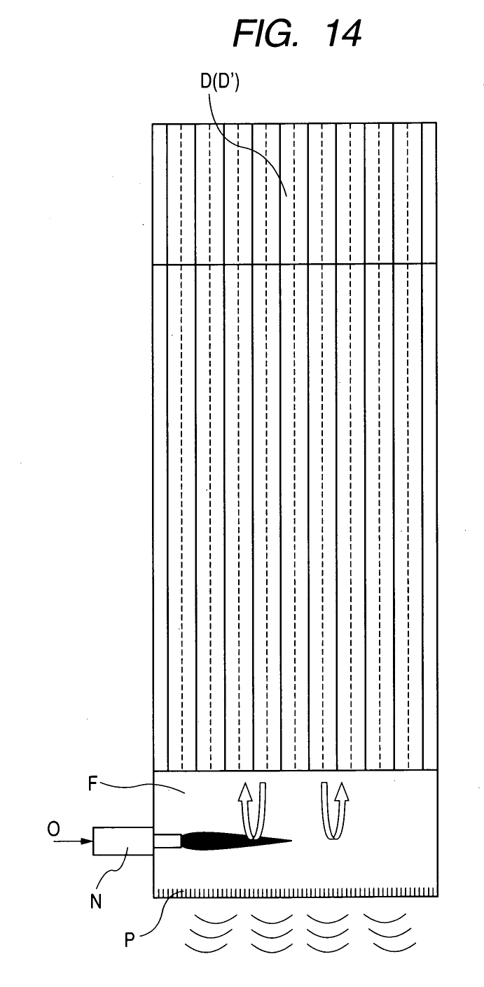

Next, a radiation heater based on the self-heat exchanger having the configuration shown in FIG. 5 will be described. FIG. 14 depicts a radiation heater according to the ninth embodiment of implementation of the present invention. This radiation heater has the same configuration as the self-heat exchanger of FIG. 5 except that a burner (N) is provided in the space portion (F) to which the fluid is forwarded and a heat radiating plate (P) having a high heat conductance and heat radiation is provided in a part of the wall parting the space portion (F) from the exterior. In the present radiation heater, as the fluid there is used a gas containing an oxidizer reacting fuel (O) such as air.

Such a configuration can provide a high efficiency radiation heater which discards little heat energy to combustion exhaust gas by transferring the heat possessed by the combustion exhaust gas to incoming fluid having a lower temperature. The present radiation heater can be used as an energy-saving gas combustion heater having little loss of heat energy in combustion exhaust gas.

### TENTH EMBODIMENT

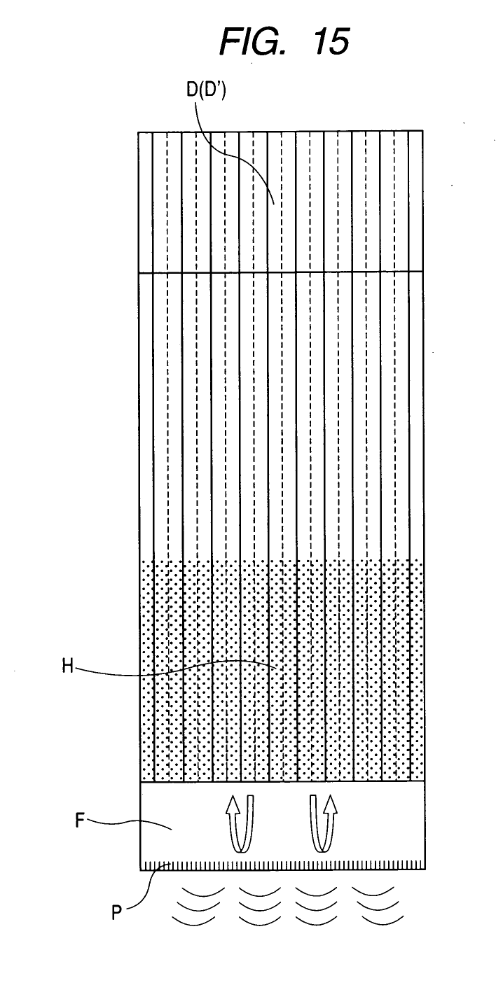

FIG. 15 depicts a radiation heater according to the tenth embodiment of implementation of the present invention. This radiation heater is a radiation heater comprising a catalytic reactor integrated to the self-heat exchanger of FIG. 8 except that a heat radiating plate (P) having a high heat conductance and heat radiation is provided in a part of the wall parting the space portion (F) to which the fluid is forwarded from the exterior. In the present radiation heater, as the fluid there may be used one containing reactive components which undergo exothermic reaction under the action of the catalyst, and in general, as the catalyst there may be used an oxidation catalyst such as platinum and as the fluid there may be used a mixture of hydrocarbon and air.

Such a configuration can provide a high efficiency radiation heater which discards little waste heat energy to fluid by transferring the majority of waste heat developed by the catalytic reaction carried on the fluid to incoming fluid having a lower temperature. The present radiation heater, too, can be used as an energy-saving gas combustion heater having little loss of heat energy in combustion exhaust gas.

Examples of the present invention are described hereinabove, and some representative modifications of the examples of the present invention will be described next.

### MODIFICATION EXAMPLE 1

This modification example 1 is the same as the aforementioned second embodiment except that at least one air-permeable structure different from the heat transfer material (BF) is provided in the gap portion of the bellows section of the heat transfer material (BF). Further, this structure is arranged to act as a spacer.

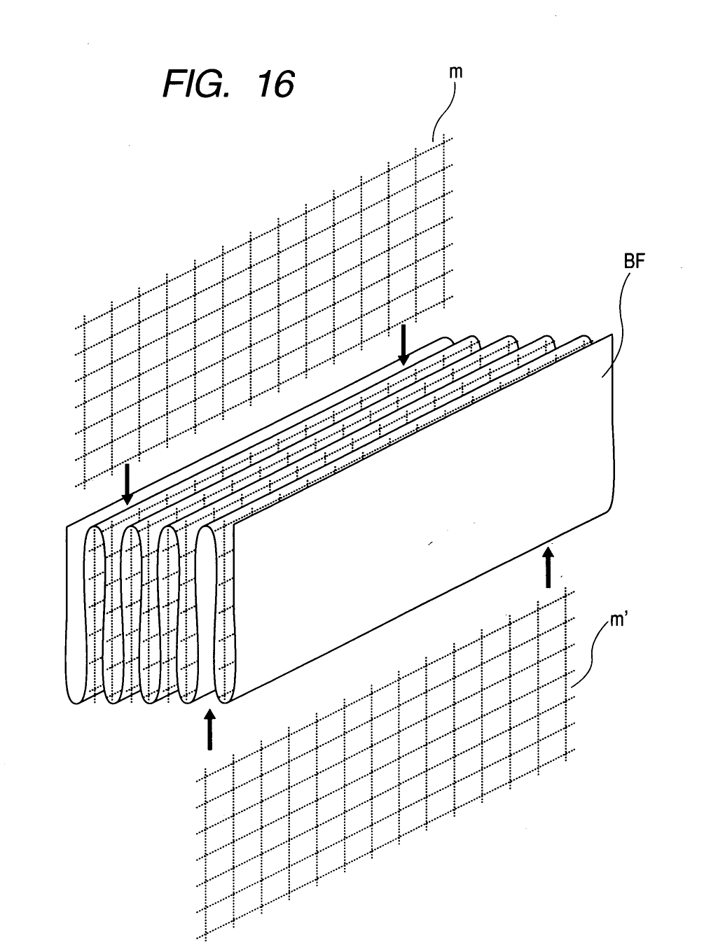

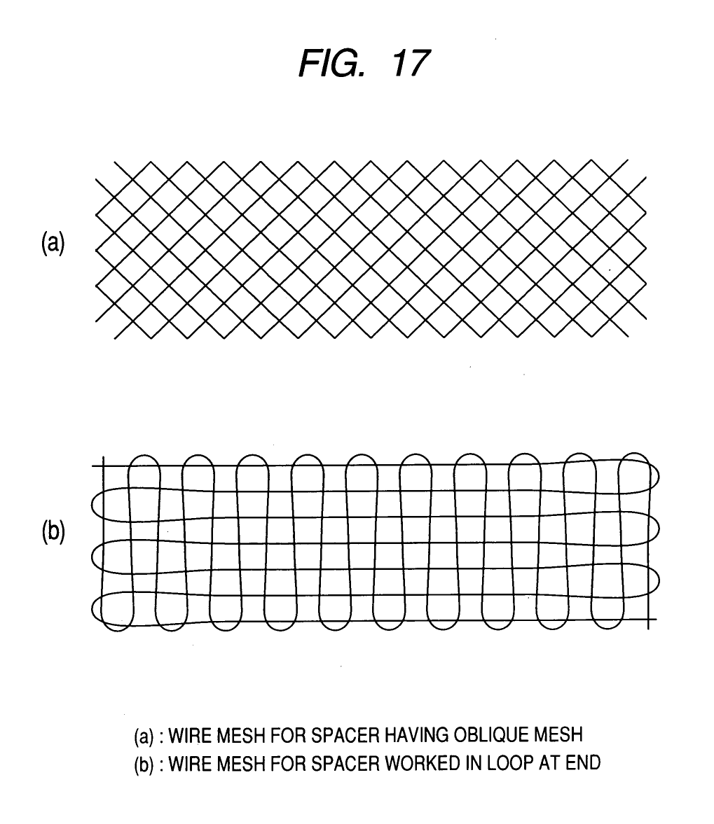

In FIG. 16, as the structure there is used a member (m, m′) of stainless steel net having almost the same shape as one of the surfaces of folded bellows-shaped heat transfer material (BF), and these members are provided in all the gap portions of the bellows-shaped heat transfer material (BF). The interposition of such a structure makes it possible to obtain advantages such as uniformalization of gap between heat transfer surfaces, enhancement of heat insulating properties in the direction of flow path by the blocking of heat radiation in the gap portion of the bellows-shaped heat transfer material (BF), uniformalization of temperature in the direction perpendicular to the flow path by the enhancement of heat transfer proper ties between the adjacent heat transfer surfaces through the structure despite the aforementioned advantage and enhancement of the mechanical strength as the structure of the bellows-shaped heat transfer material (BF) and enhance the heat exchange properties or durability. In order to improve the air permeability and reduce the pressure loss in the heat exchanger, a structure having an opening as great as possible, i.e., mesh (opening) which is greater than the diameter of wires constituting the net is preferably used. Further, the direction of mesh may be perpendicular to the ridge line (or valley line) of the heat transfer material (BF) as shown in FIG. 16 or oblique to the ridge line (or valley line) of the heat transfer material (BF) as shown in FIG. 17(a). Moreover, when a net-shaped structure obtained by bending a wire into a loop as shown in FIG. 17(b) is used rather than the net-shaped member having a cut section of wire at the end thereof, the damage of the heat transfer material (BF) or the filter material described below by the end of wire can be prevented.

Next, an example of the results of verification of the aforementioned modification example 1 will be described. Table 4 indicates the properties of a self-heat exchange type catalytic reactor (No. 3 apparatus made on experimental basis) comprising a bellows-shaped heat transfer material (BF) obtained by bending a stainless steel foil having the same dimension as No. 1 apparatus made on experimental basis, i.e., 0.03 mm thick, 1,600 mm long, 200 mm wide at an interval of 40 mm at right angle to the longitudinal direction to form 40 surfaces, supporting an alumina-supported platinum catalyst on the both sides of the surfaces of the heat transfer material (BF) having a width of about 100 mm in the vicinity of the end at which the fluid is forwarded and 39 sheets of structure provided in the respective gap portion of the bellows which structure being obtained by cutting a plain weave stainless steel net (percent opening: 73.9%) having a wire diameter of 0.45 mm and 8 mesh into a rectangle having a size of 40 mm×175 mm in the direction parallel to the direction of mesh. In this case, the distance between the gap portions is about 1 mm. In all VOC's, the reaction continues self-oxidatively under the reaction conditions set forth in Table 4. As can be seen in the comparison with the results of Table 3, the heat exchange efficiency is raised by 10% or more under the same flow rate conditions despite the fact that the heat transfer area is about two third. In the case of toluene, the heat exchange efficiency reached so far as 92% at a flow rate of 0.64 L/s. This is accompanied by remarkable reduction of VOC concentration allowing the self-oxidative continuance of catalytic combustion, and in the case of toluene flowing at the same rate, reaction proceeds even at a concentration as low as 0.023%. Further, removal rate of VOC shows generally drastic enhancement as compared with that of No. 2 apparatus made on experimental basis. For example, even at a spatial velocity as high as 2.92 L/s (=32,800 h⁻¹) as calculated in terms of flow rate, 0.06% toluene is completely self-oxidatively decomposed to CO₂ and H₂O at a removal rate of 99%.

TABLE 4
Catalytic combustion of low concentration combustible gas by self-heat exchange
type catalytic reactor (No. 3 reactor made on experimental basis)

| | | | | | | | Temperature | Heat |
|---|---|---|---|---|---|---|---|---|
| Reactive | Flow | Inlet | Outlet | Removal | Inlet | Outlet | of folded | exchange |
| gas | rate | concentration | concentration | rate | temperature | temperature | portion | efficiency* |
| component | L/s | % | % | % | ° C. | ° C. | ° C. | % |
| Ethylene | 0.33 | 0.0227 | 0.0007 | 99.7 | 26 | 35 | 116 | 89 |
| | 0.62 | 0.0246 | 0.0005 | 98.0 | 26 | 39 | 129 | 88 |
| | 1.13 | 0.0410 | 0.0007 | 98.3 | 26 | 43 | 143 | 85 |
| | 1.98 | 0.0607 | 0.0012 | 98.0 | 26 | 51 | 160 | 81 |
| | 2.93 | 0.0801 | 0.0015 | 98.1 | 26 | 61 | 187 | 79 |
| Propane | 0.33 | 0.1115 | 0.0107 | 90.4 | 27 | 66 | 422 | 90 |
| Propylene | 0.33 | 0.0197 | 0.0002 | 99.0 | 22 | 37 | 136 | 87 |
| Ethanol | 0.31 | 0.120 | 0.006 | 94.4 | 22 | 50 | 268 | 89 |
| Toluene | 0.34 | 0.0200 | 0.003 | 82.6 | 22 | 19 | 154 | 87 |
| | 0.64 | 0.023 | 0.001 | 95.9 | 23 | 39 | 213 | 92 |
| | 1.14 | 0.025 | 0.000 | 98.6 | 22 | 50 | 229 | 87 |
| | 1.59 | 0.051 | 0.000 | 99.3 | 22 | 68 | 302 | 83 |
| | 2.00 | 0.044 | 0.000 | 99.1 | 22 | 73 | 286 | 80 |
| | 2.92 | 0.060 | 0.001 | 99.0 | 22 | 93 | 320 | 76 |

*Heat exchange efficiency = {(Temperature of folded portion − outlet temperature)/(Temperature of folded portion − inlet temperature)} × 100

### MODIFICATION EXAMPLE 2

This modification example 2 has the same configuration as the aforementioned eighth embodiment except that a material having a filtrating function is formed into a bellows-shaped heat transfer material (BF) using a structure for spacer.

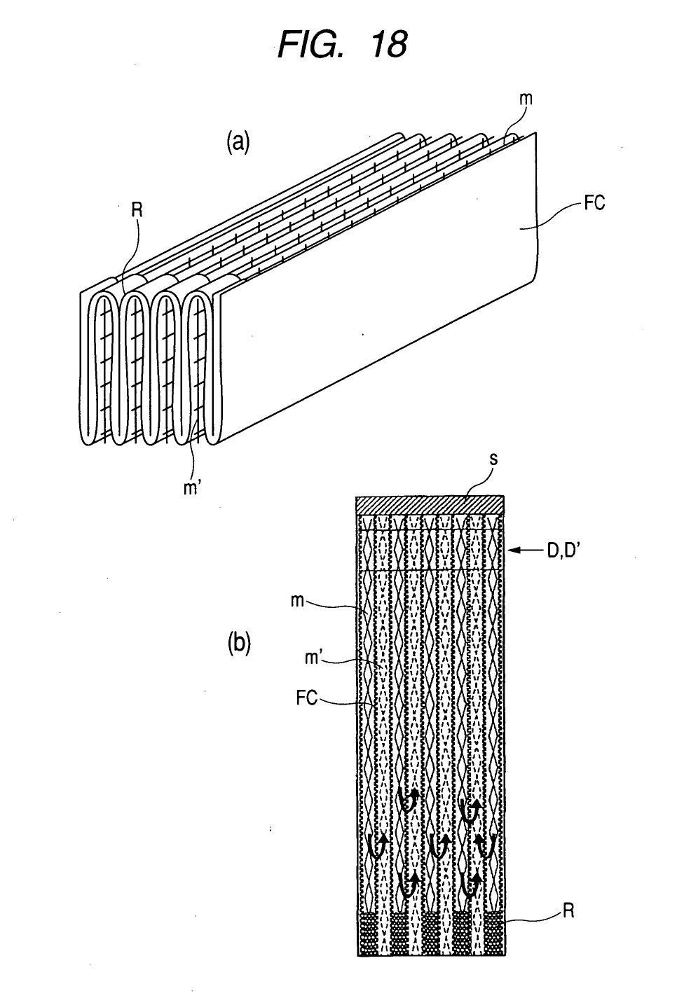

In accordance with the modification example comprising a structure provided in the gap portion of the heat transfer material as a spacer, a material having a low structural strength which has heretofore been considered difficultly used as heat transfer material, too, can be used as a bellows-shaped heat transfer material (BF). FIG. 18 depicts the use of a heat-resistant filter cloth (FC) capable of catching combustible fine particles such as PM discharged from diesel engine as a bellows-shaped heat transfer material (BF) (self-heat exchange type filter trap) in combination with the structure (m, m′). By folding the filter cloth (FC) at one end thereof to raise the thickness thereof (portion R in FIG. 18(a)), folding further the filter cloth into bellows, and then compressing the folded filter cloth in the lateral direction, the gap at one side of the filter cloth (FC) is closed at one end of the longitudinal direction of the bellows by the filter cloth (FC) itself. By installing the filter cloth (FC) in a rectangular parallelepiped vessel having flow path inlet/outlet, and then closing the end thereof on which the filter is not folded with a proper sealing material (s in FIG. 18(b)) and adhering the gap between the portion at which the folded portion of the filter cloth (FC) is exposed to the exterior (R) and the heat exchanger vessel to each other or closing the gap therebetween with a proper sealing material (not shown), a self-heat exchange type filter trap is provided. Explaining this configuration in more detail, FIG. 18(b) is a front perspective view of this structure, and the fluid containing combustible particles (typically a combustion exhaust gas) which has entered through the inlet (D) shown disposed front permeates through the filter cloth (FC) at parts having a high air permeability by which fine particles have not been caught too much while moving downward through the front gap of the bellow structure having a spacer (m) disposed therein, flows upward through the back gap portion having a spacer (m′) disposed therein, and is then discharged through the back outlet (D′). During this procedure, self-heat exchange is made between the counterflow paths.

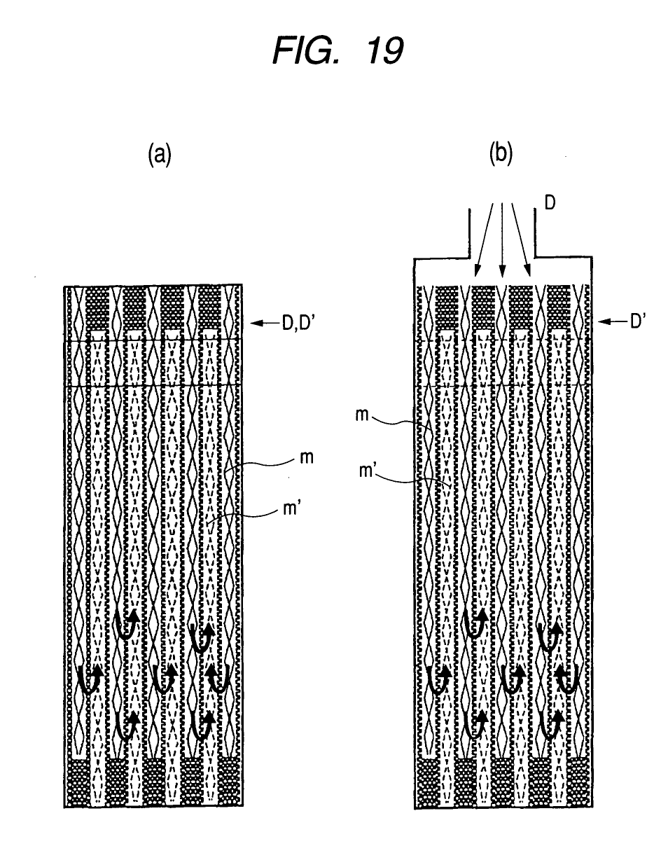

Further, FIG. 19(a) is a front perspective view of a self-heat exchange type filter trap obtained by not only folding the same filter cloth (FC) as in FIG. 18(a) at one end thereof to raise the thickness but also folding the filter cloth (FC) at the other end thereof in the opposite direction to raise the thickness, and then forming the filter cloth (FC) into bellows using a spacer (m; disposed on the front; m′; disposed on the back). In this arrangement, the both ends of the gap portions of the bellows are alternatingly closed. As a result, the sealing material (s) shown in FIG. 18(b) is not needed, making it possible to simplify the structure as self-heat exchange type filter trap. Further, in the alternatingly-sealed bellows-shaped heat transfer material (BF), the fluid inlet (D) can be disposed above rather than on the front as in the aforementioned case as shown in FIG. 19(b). The outlet (D′) is disposed on the back as in FIG. 19(a). By disposing the inlet at this position, the fluid can easily flow uniformly into a plurality of gap portions of forward flow path of the bellows-shaped heat transfer material (BF), making it possible to enhance the heat exchange properties or particle catching function. In this case, of course, the direction of flow path can be reversed.

### MODIFICATION EXAMPLE 3

This modification example 3 has the same configuration as the aforementioned second embodiment except that a functional material such as catalyst, adsorbent, heat regenerating material and filter material is provided in the gap portion of the heat transfer material (BF).

While the aforementioned embodiments 4, 5 and 8 are described with reference to the case where all of the catalyst, adsorbent and heat regenerating material act also as a heat transfer material (BF) or are supported directly on the heat transfer material (BF), this modification example 3 comprises such a functional material provided in the gap portion of the heat transfer material separately of the heat transfer material (BF).

The first aspect of the present modification example 3 comprises a functional material such as catalyst, adsorbent and heat regenerating material supported on the structure for spacer used in Modification Example 1.

Further, the second aspect of the present modification example 3 comprises a structure which acts both as spacer and functional material. For example, there may be used a method which comprises filling the gap portion uniformly with pelletized catalysts having a substantially uniform particle diameter and a proper mechanical strength.

Further, the third aspect of the present modification example 3 comprises a functional material provided in the gap portion in addition to the structure for spacer.

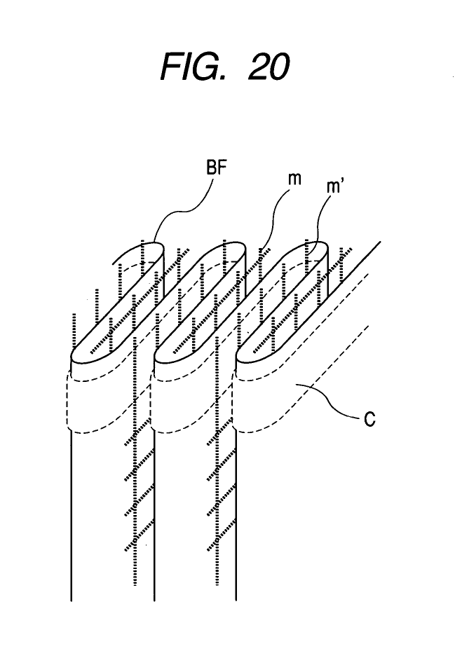

Herein, an example of the third aspect of the present modification example 3 is shown in FIG. 20. This example indicates the site on a bellows-shaped heat transfer material (BF) in the vicinity of the end thereof to which the fluid is forwarded, with the heat transfer material (BF) interleaving the same spacer (m: forward flow path; m′: backward flow path) as shown in FIG. 16. An arrangement is shown that a band-shaped heat-resistant cloth (CL) supporting a functional material such as catalyst is further provided interposed between the heat transfer material (BF) and the spacer (m′) in this vicinity. By thus interposing a functional material separate of the heat transfer material (BF), the functional material can be disposed only on the forward flow path side or backward flow path side of BF, making it possible to enhance various performances.

Further, a substantiation example of the aforementioned example (FIG. 20) of the third aspect of the present modification example 3 will be described. Table 5 indicates the properties of a self-heat exchange type catalytic reactor (No. 4 apparatus made on experimental basis) comprising a band-shaped heat-resistant cloth (CL) with a length of 1,600 mm and a width of 40 mm supporting a platinum catalyst provided only in the backward flow path in a self-heat exchanger in the vicinity of the end thereof to which the fluid is forwarded, which self-heat exchanger comprising a wire mesh-shaped structure (m, m′) having the same dimension and configuration as that of No. 3 apparatus made on experimental basis provided therein except that no catalyst is supported on the heat transfer material (BF) (BF). As compared with the results of Table 4, the heat exchange efficiency showed an enhancement of about 2% under the same conditions. Further, referring to ethylene, even at a spatial velocity as high as 1.98 L/s (22,300 h⁻¹) in terms of flow rate, a heat exchange efficiency almost equal to the theoretical value set forth in Table 1 can be obtained. This is presumably attributed to the arrangement such that more heat is recovered to upstream (forward flow path) because the catalytic reaction occurs only on the backward flow path side in addition to the aforementioned advantage of the structure for spacer (m, m′).

TABLE 5
Catalytic combustion of low concentration combustible gas by self-heat exchange
type catalytic reactor (No. 4 reactor made on experimental basis)

| | | | | | Temperature | Heat |
|---|---|---|---|---|---|---|
| | Total | Inlet | Inlet | Outlet | of folded | exchange |
| Reactive gas | flow rate | concentration | temperature | temperature | portion | efficiency* |
| component | L/s | % | ° C. | ° C. | ° C. | % |
| Ethylene | 0.33 | 0.0215 | 27 | 39 | 148 | 91 |
| | 0.63 | 0.0260 | 28 | 44 | 172 | 90 |
| | 1.13 | 0.0515 | 28 | 51 | 231 | 90 |
| | 1.98 | 0.0807 | 29 | 65 | 300 | 88 |
| Propane | 0.33 | 0.1610 | 26 | 58 | 529 | 94 |
| | 0.63 | 0.1810 | 26 | 54 | 429 | 93 |

*Heat exchange efficiency = {(Temperature of folded portion − inlet temperature)/(Temperature of folded portion + outlet temperature − inlet temperature)} × 100

No. 5 apparatus is prepared on experimental basis in the same manner as in No. 4 apparatus made on experimental basis except that it is further provided with a filtrating function, a heat-resistant cloth (CL) made of mullite supporting vanadium pentaoxide which has catalysis for solid carbon oxidation is brought into close contact with the end of the fluid forwarding space portion of the heat transfer material (BF) and the direction of the gas flow path is arranged opposite to the case of Table 5, that is, such that the catalyst carrier is disposed on the forward flow path side. This apparatus is verified for properties as self-heat exchange type filter trap. The fluid used herein is room temperature air having carbon black suspended therein in an amount of from 0.1 to 1 mg/L that imitates diesel exhaust gas. In order to raise the reaction temperature, H₂ is further added to the air in a concentration of 1.5%. The flow rate of this mixed gas is 0.33 L/s. As a result, the reaction heat generated by the oxidation of H₂ on the platinum catalyst and the self-exchange function caused the average temp Tᵣₒ at the turning portion of this reactor to rise to 567° C. and the percent carbon removal φ (=Wcox/(Wc+Wcox)×100) determined from the amount of carbon black which has passed through the present apparatus made on experimental basis without being caught (Wc=0.109 g) and the amount of burnt carbon calculated from CO₂ and CO produced by the oxidation of carbon black (Wcox=0.175 g) is 62%. The heat exchange efficiency determined from the aforementioned Tro, inlet temperature Tᵢ (29° C.) and outlet temperature Tₒ (123° C.) is about 83%.

### MODIFICATION EXAMPLE 4

This modification example 4 is a self-heat exchange type heat exchanger having the same function as the aforementioned second embodiment except that the heat transfer material is partly opened to form a fluid forwarding space portion.

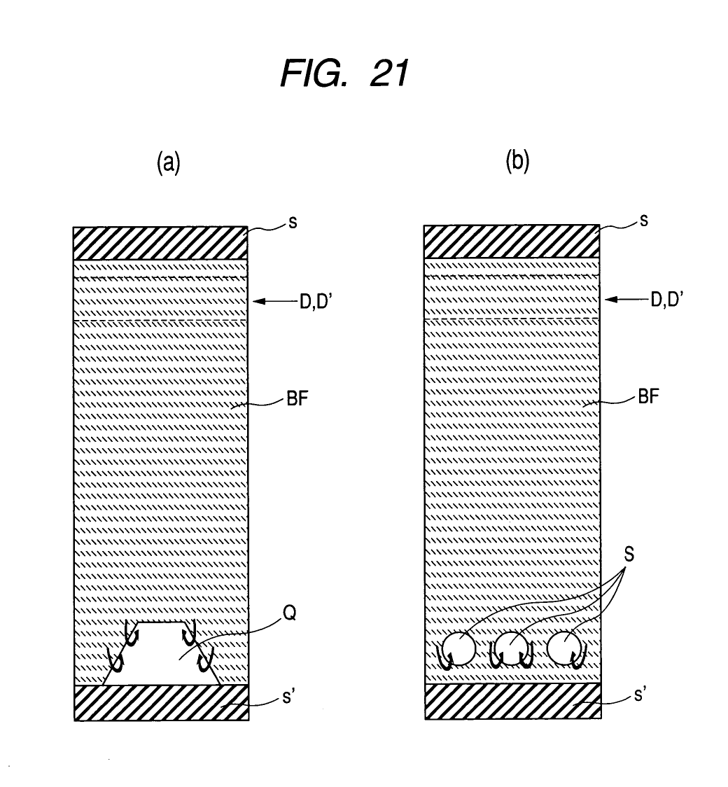

While the self-heat exchange type heat exchanger described in the aforementioned second embodiment uses as a fluid forwarding portion (F) an end formed by bending a heat transfer material (BF) into bellows as it is, a first aspect of the present modification example 4 concerns an arrangement that the end of the heat transfer material in this vicinity is partly notched to intentionally form the shape of border or space to which the fluid is forwarded. A specific example is shown in FIG. 21(a). This is a fluid forwarding portion (Q) formed by cutting part of the heat transfer material (BF) on one bent surface of the bellows-shaped heat transfer material (BF) away in the form of trapezoid. The other surfaces may be cut away in the same form at the same or different position or in the form of triangle, rectangle or other forms. In this arrangement, a fluid forwarding space portion can be formed without providing any gap between the heat transfer material (BF) and the sealing material (s′).

A second aspect of the present modification example 4 concerns the same configuration as the aforementioned second embodiment except that the various bent surfaces of the heat transfer material (BF) are provided with a opening which is closed at the circumference thereof to form a fluid forwarding portion. An example of this configuration is shown in FIG. 21(b). In this configuration, circular openings (S) are provided at a position apart from the fluid inlet/outlet on the various bent surfaces of the bellows-shaped heat transfer material (BF). Herein, the basic difference from FIG. 21(a) is that the opening does not overlap the end of the heat transfer material (BF) but occupies a closed flat area. There may be provided a plurality of openings (S) in every bent surface as shown or only one opening (S) in every bent surface. By providing such an opening (S), a flow path for self-heat exchange can be formed without taking the trouble to provide the end of the heat transfer material with a space for forwarding fluid.

### MODIFICATION EXAMPLE 5

This modification example 5 concerns a combination of an air-impermeable heat transfer material (BF), a structure for spacer and a filter cloth. In other words, this modification example has the same configuration as the aforementioned modification example 1 comprising a heat transfer material (BF) and a structure for space (m, m′: wire mesh) in combination except that the structure extends beyond the end of the fluid forwarding portion of the heat transfer material (BF) and a filter cloth (FC) is formed therearound in the form of bellows.

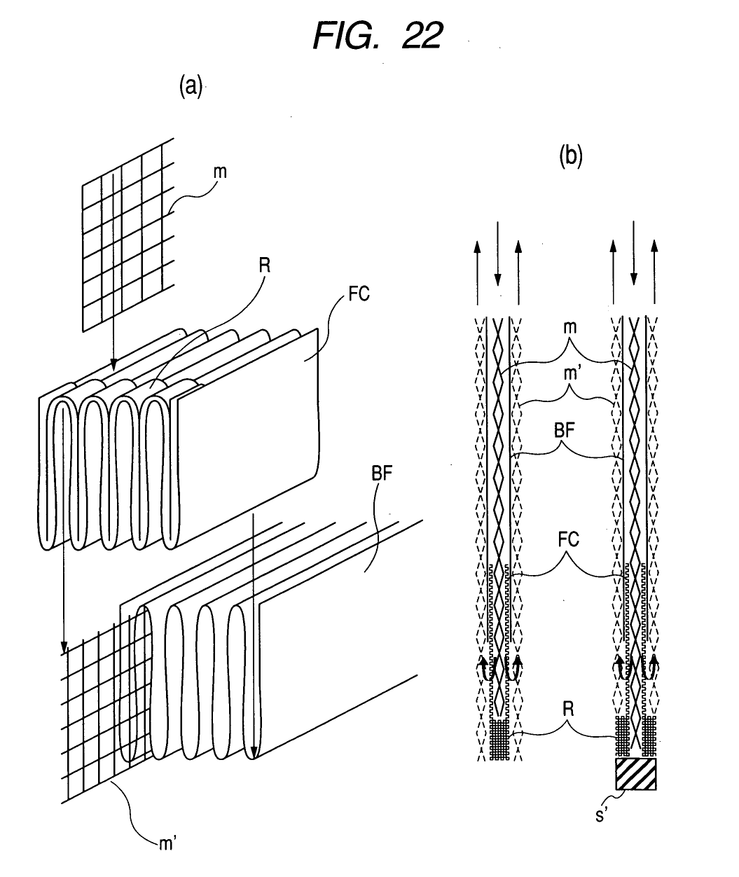

FIG. 22 depicts an example of the present modification example 5. As shown in FIG. 22(a), a rectangular spacer (m′) is provided in the air-impermeable heat transfer material (BF) on the backward flow path side thereof. During this procedure, disposition is made such that the end of the spacer (m′) extends beyond the end of the fluid forwarding portion of the heat transfer material (BF). Subsequently, the heat transfer material (BF) is covered with a filter cloth (FC) which has been formed into bellows and bent at the end thereof to have a raised thickness (R) in such an arrangement that it extends over a part of the heat transfer material (BF) and the protruding portion of the spacer (m′). Further, a spacer (m) is provided in the gap portion on the forward flow path side in such an arrangement that it does not overlap the portion R and extends over both the filter cloth (FC) and the heat transfer material (BF).

FIG. 22(b) is a sectional view illustrating more definitely the positional relationship of these structures taken on the cross-sectional plane perpendicular to the heat transfer surface. Since the filter cloth (FC) extends beyond the end of the heat transfer material (BF) and is sealed by the folded portion at the forward end thereof, an arrangement is established such that the fluid flows through the filter cloth (FC) into the backward flow path having the spacer (m′) provided therein, and this arrangement acts as a self-heat exchanger provided with a filter trap as a result. The direction of folding of the filter cloth (FC) may be reversed and the end of the gap portion on the backward flow path side may be sealed (right diagram in FIG. 22(b)).

### MODIFICATION EXAMPLE 6

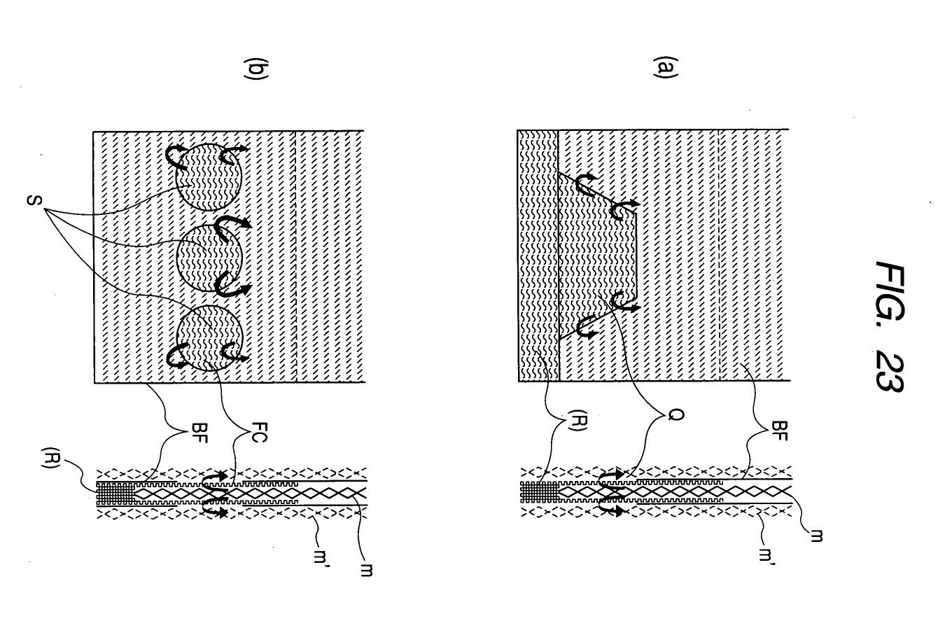

This modification example 6 concerns a self-heat exchange type filter trap comprising a heat transfer material (BF) having the same configuration as in Modification Example 4, a structure for spacer (m, m′) and a filter cloth in combination. FIG. 23 depicts two examples of the present modification example 6.

In FIG. 23(a), a notched portion as shown in FIG. 21(a) is formed in the end of the heat transfer material and a filter cloth (FC) and a structure for spacer (m, m′) are provided therein instead of extending the spacer beyond the end of the heat transfer material, whereby an air-permeable portion (Q) having a filtrating function is formed without extending the spacer for forwarding flow path (m) beyond the end of the heat transfer material. In this arrangement, the end of the heat transfer material (BF) and the spacer (m) can be flushed with each other, making it easy to assemble them into a filter trap.

Further, a filter cloth (FC) and a structure for spacer (m, m′) may be disposed in a heat transfer material (BF) as shown in FIG. 21(b) having an opening which does not overlap the end of the heat transfer material as shown in FIG. 23(b). In this arrangement, the ends of the heat transfer material (BF), the filter cloth (FC) and the spacer (m′) overlap each other (the end of the spacer (m) stands back from the end of these members by R), making it more easy to assemble them into a filter trap.

### INDUSTRIAL APPLICABILITY

As mentioned above, the heat exchanger according to the present invention and the reactor and radiation heater comprising the same have a great heat exchange area in a limited capacity, can be relatively easily prepared and provide drastic enhancement of heat exchange efficiency of heat exchanger, making it possible to provide a self-heat exchange type reactor or energy-saving radiation heater comprising this heat exchanger, optionally of self-heat exchange type, and a self-heat exchanger, catalytic reaction, a burner, etc., and they are suitable for use in the art of heat engineering for saving the energy consumption and the art of environmental technique aiming at the purification of atmosphere or exhaust gas.

1. A heat exchanger comprising:
a partition type heat transfer material for parting a high temperature fluid and a low temperature fluid from each other, wherein
the heat transfer material is bellows-shaped and is arranged such that both the fluids flow parallel or counter to each other mainly through the gap portion in the bellows section of the heat transfer material along the ridge line or valley line thereof.

2. A self-heat exchange type heat exchanger comprising:
a partition type heat transfer material for parting a high temperature fluid and a low temperature fluid from each other, wherein
the heat transfer material is bellows-shaped and is arranged such that both the fluids flow counter to each other mainly through the gap portion in the bellows section of the heat transfer material along the ridge line or valley line thereof,
the heat transfer material has a fluid forwarding space portion at one or both ends thereof crossing the ridge line of the bellows section for forwarding one of the fluids to the gap portion in the bellows section on the opposite side thereof, and
the fluid which has been forwarded to the opposite side via the fluid forwarding space portion acts as the other fluid to be heat-exchanged to perform heat exchange.

3. A reactor comprising:
(a) a self-heat exchange type heat exchanger having a partition type heat transfer material for parting a high temperature fluid and a low temperature fluid from each other, wherein
the heat transfer material is bellows-shaped and is arranged such that both the fluids flow counter to each other mainly through the gap portion in the bellows section of the heat transfer material along the ridge line or valley line thereof and the heat transfer material has a fluid forwarding space portion at one or both ends thereof crossing the ridge line of the bellows section for forwarding one of the fluids to the gap portion in the bellows section on the opposite side thereof, and
the fluid which has been forwarded to the opposite side via the fluid forwarding space portion acts as the other fluid to be heat-exchanged to perform heat exchange; and
(b) a heating element or heat-absorbing element provided in the fluid forwarding space portion of the heat exchanger.

4. The reactor as described in claim 3, wherein a catalyst which accelerates exothermic reaction is supported on the entire surface of the heat transfer material of the heat exchanger or the surface thereof in the vicinity of the fluid forwarding space portion and as the fluid there is used one including the reactive components.

5. The reactor as described in claim 3, wherein as the heat transfer material of the heat exchanger there is used one having heat storage capacities, a catalyst which accelerates exothermic reaction is supported on the entire surface of the heat transfer material of the heat exchanger or the surface of the region close to the inlet/outlet of the fluid, an adsorbent which adsorbs the reactive components at low temperature and releases the reactive components at high temperature is supported on the entire surface of the heat transfer material of the heat exchanger or the surface thereof in the vicinity of the fluid forwarding space portion and as the fluid there is used one including the reactive components.

6. The reactor as described in claim 3, further comprising:
a particle removing filter for catching and removing fine particles provided in close contact with the side of the heat transfer material of the heat exchanger to which the fluid is forwarded.

7. The reactor as described in claim 4, further comprising:
a particle removing filter for catching and removing fine particles provided in close contact with the side of the heat transfer material of the heat exchanger to which the fluid is forwarded.

8. The reactor as described in claim 3, wherein the heat transfer material includes a filtrating function allowing gas permeation and particle catch, and is not provided with a fluid forwarding space portion through which the fluid is forwarded from one side to the other side of the heat transfer material.

9. A radiation heater comprising:
a self-heat exchange type heat exchanger having a partition type heat transfer material for parting a high temperature fluid and a low temperature fluid from each other, wherein
the heat transfer material is bellows-shaped and is arranged such that both the fluids flow counter to each other mainly through the gap portion in the bellows section of the heat transfer material along the ridge line or valley line thereof, and
the heat transfer material has a fluid forwarding space portion at one or both ends thereof crossing the ridge line of the bellows section for forwarding one of the fluids to the gap portion in the bellows section on the opposite side thereof, and
the fluid which has been forwarded to the opposite side via the fluid forwarding space portion acts as the other fluid to be heat-exchanged to perform heat exchange; and
(b) a burner disposed in the fluid forwarding space portion of the heat exchanger, wherein the wall parting the fluid forwarding space portion in which the burner is disposed from the exterior is formed by a heat radiating plate.

10. A radiation heater comprising:
a self-heat exchange type heat exchanger having a partition type heat transfer material for parting a high temperature fluid and a low temperature fluid from each other, wherein
the heat transfer material is bellows-shaped and is arranged such that both the fluids flow counter to each other mainly through the gap portion in the bellows section of the heat transfer material along the ridge line or valley line thereof, and
the heat transfer material has a fluid forwarding space portion at one or both ends thereof crossing the ridge line of the bellows section for forwarding one of the fluids to the gap portion in the bellows section on the opposite side thereof, and
the fluid which has been forwarded to the opposite side via the fluid forwarding space portion acts as the other fluid to be heat-exchanged to perform heat exchange; and
(b) an exothermic reaction-accelerating catalyst supported on the entire surface of the heat transfer material of the heat exchanger or the surface thereof in the vicinity of the fluid forwarding space portion, wherein
the wall parting the fluid forwarding space portion from the exterior is formed by a heat radiating plate and as the fluid there is used one including the reactive components.

11. The self-heat exchange type heat exchanger as described in claim 2, wherein at least one air-permeable structure different from the heat transfer material is provided in the gap portion of the bellows section of the heat transfer material.

12. The self-heat exchange type heat exchanger as described in claim 11, wherein the air-permeable structure acts as a spacer.

13. The self-heat exchange type heat exchanger as described in claim 2, further comprising:
a functional material such as catalyst, adsorbent, heat storage material and filter material provided in the gap portion of the bellows section of the heat transfer material.

14. The self-heat exchange type heat exchanger as described in claim 2, wherein the surface of the heat transfer material is partly opened to form a fluid forwarding space portion.

15. The self-heat exchange type heat exchanger as described in claim 14, wherein the end of the heat transfer material is partly cut away to form a fluid forwarding space portion.

16. The self-heat exchange type heat exchanger as described in claim 14, wherein the surface of the heat transfer material is partly provided with one or a plurality of openings which are closed at the circumference thereof to form a fluid forwarding space portion.

17. The self-heat exchange type heat exchanger as described in claim 12, wherein as the heat transfer material there is used one having no air permeability, and the self-heat exchange type heat exchanger is formed by the heat transfer material, a structure for spacer and a filter cloth in combination.

18. The self-heat exchange type heat exchanger as described in claim 17, wherein the structure extends beyond the end of the fluid forwarding space portion of the heat transfer material, and a filter cloth is formed therearound in the form of bellows.

19. The self-heat exchange type heat exchanger as described in claim 17, wherein the surface of the heat transfer material is partly opened to form a fluid forwarding space portion, or the end of the heat transfer material is partly cut away to form a fluid forwarding space portion.

20. The reactor as described in claim 8, wherein the heat transfer material having a filtrating function is retained and formed in the form of a structure for spacer in the form of bellows.
